(19) United States
(12) Patent Application Publication
(10) Pub. No.: US 2011/0045141 A1
(43) Pub. Date: Feb. 24, 2011

(54) FEED, METHOD OF PRODUCING FEED, AND LARVA PRICKING APPARATUS

(76) Inventors: Shunji Natori, Ibaraki (JP); Masahide Tanaka, Kyoto (JP)

Correspondence Address: FISH & RICHARDSON P.C. (NY), P.O. BOX 1022, MINNEAPOLIS, MN, 55440-1022, US

(21) Appl. No.: 12/990,252

(22) PCT Filed: May 11, 2009
(86) PCT No.: PCT/JP2009/058743

§ 371 Date: Oct. 29, 2010

(30) Foreign Application Priority Data
Jun. 24, 2008 (JP) 2008-164713
Dec. 5, 2008 (JP) 2008-1244664

(51) Int. Cl. A23K 1/00

(52) U.S. Cl. 426/61; 99/485

(57) ABSTRACT

Feed contains at least part of an insect larva having an antimicrobial activity.

### TECHNICAL FIELD

The present invention relates to feed used in the livestock, marine-products, and like industries, to a method of producing such feed, and to a larva pricking apparatus for obtaining a useful substance from an insect larva.

### BACKGROUND ART

In the livestock, marine-products, and like industries, it has been common to mix antibiotics to feed to promote growth; nowadays, however, the harm of such antibiotics, when remnant, is recognized. On the other hand, as substitutes for antibiotics as antimicrobial substances, proteins and peptides having an antimicrobial activity have been receiving attention, and proposals have been made to mix these to feed.

Also, in recent years, proposals have been made to make insects produce proteins and peptides having an antimicrobial activity.

### LIST OF CITATIONS

### Patent Literature

Patent Document 1: JP-A-2001-233899

### SUMMARY OF INVENTION

### Technical Problem

Unfortunately, however, no sufficient studies seem to have been made on specific methods of, specific apparatuses for, or other details about producing feed mixed with a protein or peptide having an antimicrobial activity.

In view of the foregoing, it is an object of the present invention to provide a specific composition of, and a method of producing, feed mixed with a protein or peptide having an antimicrobial activity, and to provide an apparatus for pricking (puncturing) fly larvae (maggots) for the production of a peptide having an antimicrobial activity.

### Solution to Problem

To achieve the above object, according to one aspect of the present invention, feed contains at least part of an insect larva having an antimicrobial activity (a first configuration).

In the feed of the first configuration described above, preferably, the insect is a fly (a second configuration).

In the feed of the second configuration described above, preferably, the feed contains at least part of a fly larva with no residual sustenance component in a body thereof (a third configuration).

In the feed of the third configuration described above, preferably, the feed contains at least part of a fly larva that is pricked and then kept away from sustenance (larva feed) for a while with moisture maintained (a fourth configuration).

In the feed of the third configuration described above, preferably, the feed contains at least part of a fly larva that is kept away from sustenance for a while with moisture maintained and then pricked (a fifth configuration).

In the feed of the first configuration described above, preferably, the feed contains the entire components of the insect larva (a sixth configuration).

In the feed of the sixth configuration described above, preferably, the feed contains the insect larva in a crushed form (a seventh configuration).

In the feed of the sixth configuration described above, preferably, the feed contains a cuticular layer at the surface of the body of the insect larva (an eighth configuration).

According to another aspect of the present invention, a method of producing feed includes: a first step of obtaining an insect larva having an antimicrobial activity; a second step of drying the larva; and a third step of mixing at least part of the larva having undergone the second step in the feed (a ninth configuration).

The feed production method of the ninth configuration described above, preferably, further includes a step of crushing the dried larva having undergone the second step, wherein the larva crushed in that step is supplied to the third step (a tenth configuration).

In the feed production method of the ninth configuration described above, preferably, the first step includes a step of separating the insect larva, a step of pricking the separated larva, and a step of waiting for the pricked larva to express an antimicrobial activity (an eleventh configuration).

In the feed production method of the eleventh configuration described above, preferably, the first step further includes a step of refrigeration-anesthetizing the larva when pricking it (a twelfth configuration).

In the feed production method of the ninth configuration described above, preferably, the insect is a fly (a thirteenth configuration).

The feed production method of the ninth configuration described above, preferably, further includes: a fourth step of crushing the insect larva having undergone the second step to obtain crushed powder thereof; and a fifth step of extracting part of the crushed powder to check for production of an antimicrobial activity, wherein in the third step, the crushed powder in which production of an antimicrobial activity has been confirmed in the fifth step is mixed in the feed (a fourteenth configuration).

In the feed production method of the ninth configuration described above, preferably, the first step includes a step of obtaining the insect larva, a step of moving the obtained larva into a water current, and a step of arraying the larva spread from one another by the water current (a fifteenth configuration).

In the feed production method of the ninth configuration described above, preferably, the first step includes a step of obtaining the insect larva, a step of spreading the obtained larva from one another, and a step of arraying the spread larva one after another at a predetermined position (a sixteenth configuration).

According to yet another aspect of the present invention, a larva pricking apparatus includes: a larva arraying portion for arraying insect larvae that have been refrigeration-anesthetized; a pricking needle for pricking, for expression of an antimicrobial activity, the insect larvae that have been spread from one another after being refrigeration-anesthetized (a seventeenth configuration).

The larva pricking apparatus of the seventeenth configuration described above, preferably, further includes: a transport portion for transporting the larva arraying portion to the position of the pricking needle; and a cleaning portion for cleaning the larva arraying portion (an eighteenth configuration).

The larva pricking apparatus of the seventeenth configuration described above, preferably, further includes a needle cleaning portion for cleaning the pricking needle (a nineteenth configuration).

In the larva pricking apparatus of the seventeenth configuration described above, preferably, the insect is a fly (a twentieth configuration).

### ADVANTAGEOUS EFFECTS OF THE INVENTION

According to the present invention, it is possible to industrially produce feed having an antimicrobial activity.

### BRIEF DESCRIPTION OF DRAWINGS

FIG. 1 is a block diagram showing Example 1 of the invention.

FIG. 2 is a flow chart showing the function of the production control portion in Example 1 shown in FIG. 1.

FIG. 3 is a block diagram showing in detail the configuration of the larva anesthetizing/pricking section in Example 1 shown in FIG. 1.

FIG. 4 is a flow chart showing the basic function of the larva anesthetizing/pricking section shown in FIG. 3.

FIG. 5 is a flow chart showing in detail the function of the tray vibrating/rotating portion started at step S50 in FIG. 4.

FIG. 6 is a flow chart showing in detail the function of the position sensor portion started at step S56 in FIG. 4.

FIG. 7 is a flow chart showing in detail the function of the needle driving portion started at step S62 in FIG. 4.

FIG. 8 is a block diagram showing Example 2 of the invention.

FIG. 9 is a block diagram showing Example 3 of the invention.

FIG. 10 is a block diagram showing in detail the configuration of the larva pricking section in Example 3 shown in FIG. 9.

FIG. 11 is a flow chart related to the control of the arraying control portion in the larva pricking control portion in FIG. 10.

FIG. 12 is a flow chart related to the control of the pricking transport portion in the larva pricking control portion in FIG. 10.

### DESCRIPTION OF EMBODIMENTS

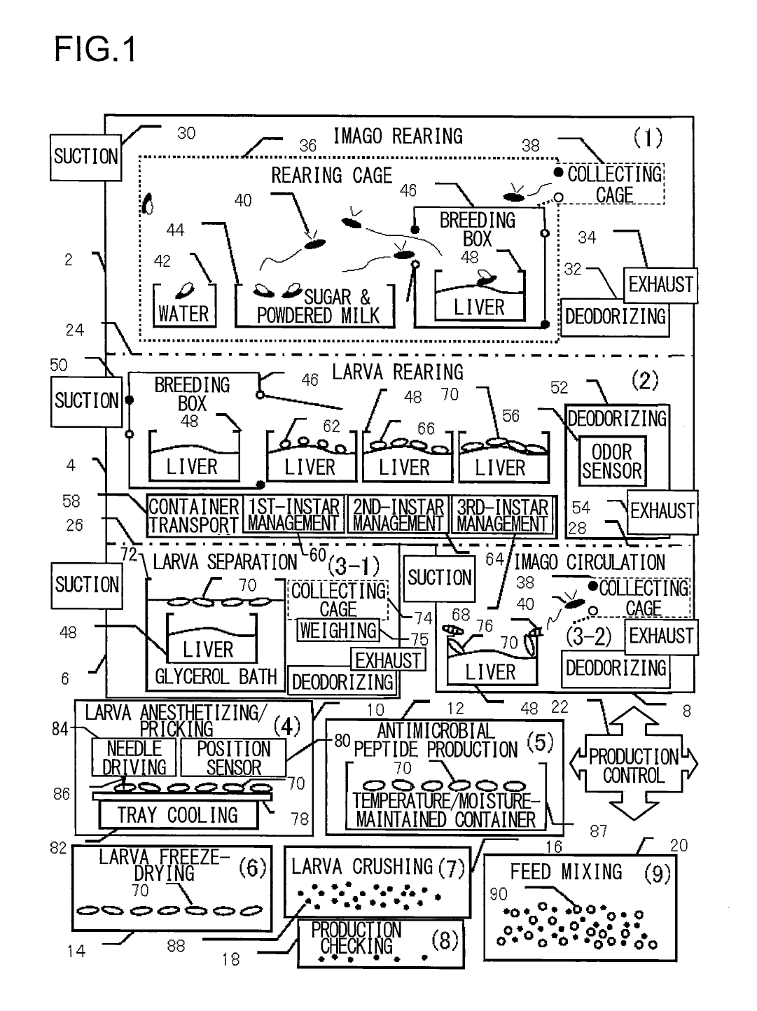

FIG. 1 is a block diagram of a feed production system using flesh-flies (Sarcophaga (Boettcherisca) peregrina), as a first example (Example 1) embodying the present invention. This system produces feed mixed with larvae that exert an antimicrobial activity when pricked (punctured). The feed production system of Example 1 includes an imago (adult) rearing section 2, a larva rearing section 4, a larva separation section 6, an imago circulation section 8, a larva anesthetizing/pricking section 10, an antimicrobial peptide production section 12, a larva freeze-drying section 14, a larva crushing section 16, a production checking section 18, and a feed mixing section 20. It should be noted that the parenthesized numbers, (1) to (9), indicate the order in which different processes are performed at the relevant parts. These parts are controlled in a concentrated fashion by a production control portion 22, which includes a computer. The feed produced according to the present invention is extremely useful as a substitute for antibiotic-mixed feed conventionally used in the livestock, marine-products, and like industries.

In FIG. 1, the imago rearing section 2, the larva rearing section 4, the larva separation section 6, and the imago circulation section 8 are as a whole made airtight so as to be hermetically sealed from outside air. These sections are ordinarily isolated, and thereby made airtight, from one another by partition walls 24, 26, and 28. As will be described later, these partition walls can be opened whenever necessary to proceed from one process to another. It should be noted that, even when one of the partition walls 24, 26, and 28 is opened, the imago rearing section 2, the larva rearing section 4, the larva separation section 6, and the imago circulation section 8 as a whole are kept airtight.

The imago rearing section 2 is provided with an environment protection system which takes in fresh air via a suction portion 30 and sends out harmless, odorless air via a deodorizing portion 32 and then an exhaust portion 34. The imago rearing section 2 itself is unlikely to give off odor, but strong odor may flows into it when the partition wall 24 is opened, hence the independent provision there of the above environment protection system.

The imago rearing section 2 is provided with a rearing cage 36, inside which imagoes (adults) 40 of flesh-flies released from a collecting cage 38 are reared at a temperature of 25° C. to 28° C. A method of collecting imagoes immediately after emergence (eclosion) into the collecting cage 38 will be described later. The imagoes 40 grow feeding on water placed in an imago sustenance (feed) container 42 and sugar and powdered milk placed in an imago sustenance container 44. It should be noted that, in the present description, the term “sustenance” is used to denote feed for larvae and imagoes as before or after being ingested, for distinction from feed as the end product and the materials therefor. Five days after emergence, imagoes enter a breeding box 46, which has an imago gate open, and deliver (give birth to) young (maggots) on larva sustenance such as animal liver placed in a larva sustenance container 48. It should be noted that flesh-flies are ovoviviparous.

Although FIG. 1 only shows one breeding box 46 with one larva sustenance container 48 loaded in it, in practice a plurality of breeding boxes 46 are provided inside the rearing cage 36, and each breeding box 46 houses a plurality of larva sustenance containers 48. The time at which each larva sustenance container 48 is loaded is managed for each individual breeding box 46.

Like the imago rearing section 2, the larva rearing section 4 is provided with an environment protection system which takes in fresh air via a suction portion 50 and sends out harmless, odorless air via a deodorizing portion 52 and then an exhaust portion 54. The larva rearing section 4 gives off strong odor due to larvae ingesting sustenance and excreting. Accordingly, the deodorizing portion 52 is provided with an odor sensor 56, so that the performance of the deodorizing portion 52 and the exhaust portion 54 is controlled in accordance with the strength of odor. The larva rearing section 4 too is kept at a temperature of 25° C. to 28° C. to let larvae grow. It should be noted that higher temperature promotes the growth of larvae. On the other hand, keeping the sustenance and temperature constant allows the growth speed to remain largely within a predetermined range, and thus leads to good growth repeatability.

With respect to the breeding box 46 provided in the imago rearing section 2, when a predetermined replacement time arrives at which a sufficient number of young are expected to have been delivered, the imago gate is closed and, with the partition wall 24 opened, the breeding box 46 is transported to the larva rearing section 4. The replacement time is determined experimentally; once determined, it will not be changed except on an occasion of reconfiguring the entire system, and therefore will not be handled as a variable in the production control described later.

From the breeding box 46 thus transported to the larva rearing section 4, with a container gate open, the larva sustenance container 48 is unloaded, which is then transported to a container transport portion 58. After the unloading of the larva sustenance container 48, a new larva sustenance container 48 is loaded in the breeding box 46, which is then returned to the imago rearing section 2. In this way, the breeding box 46 is circulated between the imago rearing section 2 and the larva rearing section 4. The unloading and loading of the larva sustenance container 48 out of and into the breeding box 46, the transport of the breeding box 46 between the imago rearing section 2 and the larva rearing section 4, and the accompanying opening and closing of the partition wall 24 are controlled by an automating mechanism.

When 24 hours pass after the unloading of any larva sustenance container 48 out of a breeding box 46, the odor sensor 56 transports that larva sustenance container 48 to a first-instar management portion 60. At this stage, first-instar larvae 62 are expected to be growing in the larva sustenance container 48. The first-instar management portion 60 stores the composition in the larva sustenance container 48 at this stage as initial values. As larvae grow, the composition in the larva sustenance container 48 changes as a result of the sustenance turning into the bodies and excretions of the larvae. The first-instar management portion 60 detects the change in the composition by inspecting the color of the mixture of sustenance and larvae inside the larva sustenance container 48, by ultrasonically inspecting the mixture, or otherwise. Next, when another 24 hours pass after the transport of any larva sustenance container 48 to the first-instar management portion 60, the container transport portion 58 transports that larva sustenance container 48 to a second-instar management portion 64. At this stage, second-instar larvae 66, which have undergone ecdysis, are expected to be growing in the larva sustenance container 48. The second-instar management portion 64 detects the composition in a similar manner, and stores the composition in the larva sustenance container 48 at this stage for comparison with the initial values. Furthermore, when yet another 24 hours pass after the transport of any larva sustenance container 48 to the second-instar management portion 64, the container transport portion 58 transports that larva sustenance container 48 to a third-instar management portion 68. At this stage, third-instar larvae 70, which have undergone ecdysis for the second time, are expected to be growing in the larva sustenance container 48. The third-instar management portion 68 detects the composition in a similar manner, and stores the composition in the larva sustenance container 48 at this stage for comparison with the initial values and with the second-instar composition, and further as third-instar larva growth information. Although FIG. 1 only shows larvae lying on the surface of the sustenance such as liver inside the larva sustenance container 48, in reality most of them stay inside the sustenance. At the stage of third-instar larvae 70, in preparation for pupation, they start to creep out onto the surface of the sustenance in search of dry places, some creeping up the inner wall of the larva sustenance container 48.

A larva sustenance container 48 for which the composition detection by the third-instar management portion 68 is completed is then, with the partition wall 26 or 28 opened, transported either to the larva separation section 6 or to the imago circulation section 8 in predetermined distribution proportions. The distribution proportions here are determined such that, generally, most larva sustenance containers 48 are transported to the larva separation section 6 and that, more specifically, when the number of third-instar larvae 70 per larva sustenance container 48 is too large, less larva sustenance containers 48 are transported to the imago circulation section 8 and, when the other way around, more larva sustenance containers 48 are transported to the imago circulation section 8. In this way, the number of imagoes 40 in the rearing cage 36 is managed such that there are enough imagoes there to produce third-instar larvae 70 but not so many as to hinder their own rearing. The distribution discussed just above is effected in the following manners: in a large-scale production system involving a large number of larva sustenance containers 48 containing third-instar larvae 70, the larva sustenance containers 48 are transported simultaneously either to the larva separation section 6 or to the imago circulation section 8 in the predetermined distribution proportions; in contrast, in a small-scale production system, the transport destinations are switched on a time series basis, for example by transporting a larva sustenance container 48 to the larva separation section 6 ten consecutive times followed by transporting one to the imago circulation section 8 once and then repeating this sequence. In this way, production control is achieved through feedback to the distribution proportion to the imago circulation section 8, while the times at which the larva sustenance containers 48 are unloaded out of and loaded into the rearing cage 36 are fixed. It should be noted that, on an occasion of reconfiguring the entire system for higher yields as mentioned above, the times at which the larva sustenance containers 48 are unloaded out of and loaded into the rearing cage 36 are handled as variables in the production control.

A larva sustenance container 48 distributed to the larva separation section 6 is immersed in a glycerol bath 72. Third-instar larvae 70 that float on the liquid surface are scooped in a collecting cage 74, and thereby the third-instar larvae 70 are separated. The weight of the collecting cage 74 is measured at a weighing portion 75. The weight of the collecting cage 74 itself is previously known, and thus the measurement here provides information on the total weight of the third-instar larvae 70 collected from each larva sustenance container 48. This information will be combined with information on the number of larvae obtained at the larva anesthetizing/pricking section 10, which will be described later, to serve as information on the weight per larva.

To make only the third-instar larvae 70 float, the glycerol bath 72 is filled with a 3% to 10% water solution of glycerol of which the specific gravity is so adjusted as to be higher than that of larvae but lower than that of sustenance such as liver. The larva separation section 6 too is provided with a suction portion, a deodorizing portion, and an exhaust portion. These are similar to those in the imago rearing section 2, and therefore no overlapping description will be repeated.

As for a larva sustenance container 48 distributed to the imago circulation section 8, if it is left unattended to as it is, the third-instar larvae 70 creep up the larva sustenance container 48 for dry places, and grow into pupae 76. From the pupae 76, imagoes 40 emerge in ten days. These imagoes 40 are collected with the gate of the collecting cage 38, in which attractant sustenance is placed, open. Since imagoes 40 are attracted to light, they may be attracted with an attractant light source placed near the collecting cage 38. After the attraction of the imagoes 40, the gate of the collecting cage 38 is closed, and the attractant sustenance is removed (in the case of light attraction, the light source does not need to be removed); the collecting cage 38 is then transported to the imago rearing section 2. The collecting cage 38 is then, with its gate opened, connected to the rearing cage 36, so that the imagoes 40 move into the rearing cage 36 by being attracted to the imago sustenance container 44 or the like. Thus, a circulation of imagoes 40 is established. The imago circulation section 8 too is provided with a suction portion, a deodorizing portion, and an exhaust portion. These are similar to those in the imago rearing section 2, and therefore no overlapping description will be repeated.

The third-instar larvae 70 separated at the larva separation section 6 are, along with the collecting cage 74, left unattended to for 24 hours, with the supply of moisture (water) maintained. The moisture here is for preventing the larvae from drying and growing into pupae. This is because larvae growing into pupae means their coming to have a harder body surface and undergoing metamorphosis toward imago tissues, and this leads to lower efficiency in the pricking process performed later. It should however be noted that this does not necessarily make the production of an antimicrobial peptide by pricking impossible, because even pupae and imagoes have the ability of producing an antimicrobial peptide. Left unattended to for 24 hours in this way, the third-instar larvae 70 have the sustenance remaining in their body completely digested, and thus have the inside of their body cleaned. Owing to the cleaning here, even when larvae are as they are mixed in feed in a later process, the feed will be saved from contamination. The progress of larva cleaning can be checked by observing larvae from outside, and thus can be checked automatically by analyzing the image or color of larvae.

The third-instar larvae 70 having the inside of their body cleaned are, along with the collecting cage 74, transported to the larva anesthetizing/pricking section 10, where they are placed on a tray portion 78. For easy detection by a position sensor portion 80, the tray portion 78 is given a black surface and is made of a material having a high thermal conductivity, such as metal. The third-instar larvae 70 placed on the tray portion 78 are then cooled to about 4° C. at a tray cooling portion 82 where ice or the like is placed. The third-instar larvae 70 are thereby anesthetized and immobilized. The positions of the individual third-instar larvae 70 in this state are detected by the position sensor portion 80, and the resulting position information is transmitted to a needle driving portion 84. Based on the position information, the needle driving portion 84 moves a needle 86 to right above one third-instar larva 70 after another to prick the third-instar larvae 70 one by one at high speed. The configuration of this larva anesthetizing/pricking section 10 will be described in detail later.

The third-instar larvae 70 pricked at the larva anesthetizing/pricking section 10 are then transported into a temperature/moisture-maintained container 87 in the antimicrobial peptide production section 12. Inside the temperature/moisture-maintained container 87, the temperature is kept at room temperature, and the third-instar larvae 70 are kept from drying. Thus, the third-instar larvae 70 transported to the antimicrobial peptide production section 12 recover from refrigeration anesthesia and, by being prevented from growing into pupae, remain third-instar larvae. Leaving the third-instar larvae 70 in this state for 24 hours causes them to produce an antimicrobial peptide in their body fluid.

Twelve hours after the transport to the antimicrobial peptide production section 12, the third-instar larvae 70 are then transported to the larva freeze-drying section 14, where they are freeze-dried. The dried third-instar larvae 70 are transported further to the larva crushing section 16, where they are crushed into larva powder 88. Whereas common proteins are denatured on heating or the like, the antimicrobial activity of the antimicrobial peptide produced by the third-instar larvae 70 is not lost on heating or drying. Thus, the activity of the antimicrobial peptide is maintained even in the larva powder 88, which has gone through the processes at the larva freeze-drying section 14 and the larva crushing section 16. Moreover, at the larva crushing section 16, the dried third-instar larvae 70 are crushed as they are, and therefore the crushed result contains not only the dried body fluid component containing the antimicrobial peptide but also the cuticular layer of the larva outer wall. The cuticular layer being a comparatively hard tissue, the larva crushing section 16 is given the sufficient ability to crush it.

Part of the larva powder 88 obtained at the larva crushing section 16 is, as an inspection sample, collected by the production checking section 18, where it is subjected to isolation by a technique such as chromatography to check for the presence of the destination substance. The larva powder 88 having undergone the sampling inspection is then transported to the feed mixing section 20, where it is mixed with and stirred with feed 90. In this way, it is possible to produce feed containing an antimicrobial peptide.

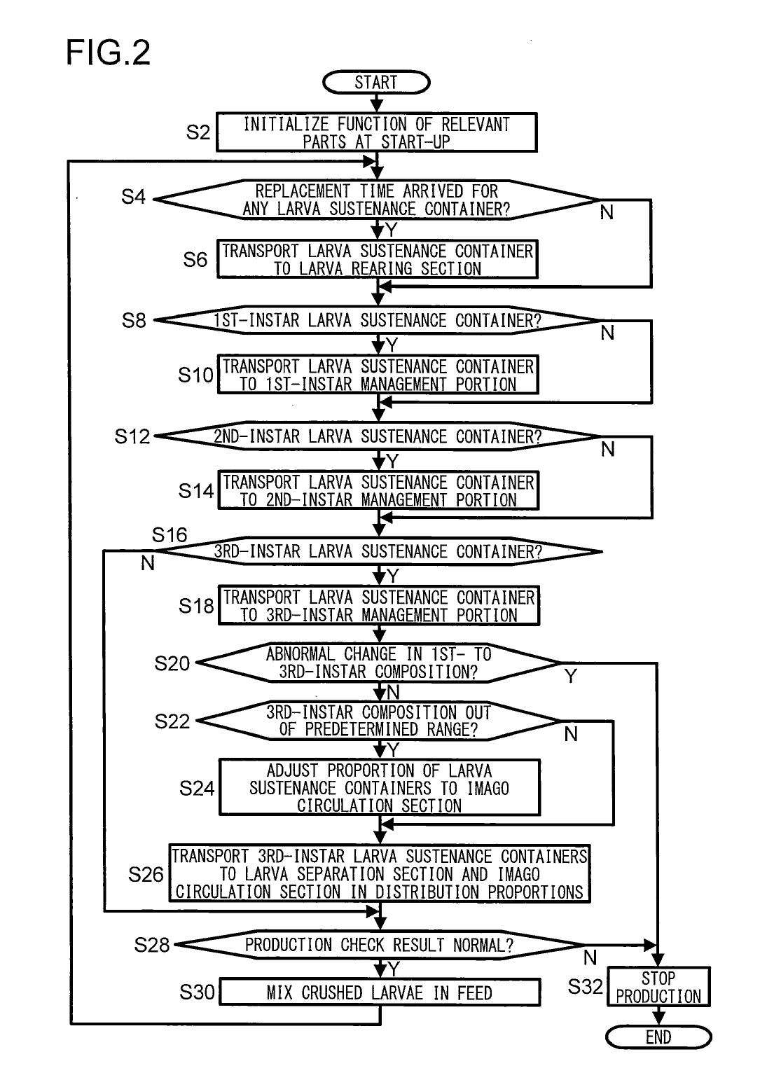

FIG. 2 is a flow chart showing the production control function that is managed in a concentrated fashion by the computer in the production control portion 22. On start-up of the computer as a result of its being turned on, first, at step S2, the function of different parts that are to be controlled is initialized, and then an advance is made to step S4.

At step S4, it is checked whether or not there is, in the rearing cage 36 in the imago rearing section 2, a larva sustenance container 48 for which the replacement time has arrived. If there is any such larva sustenance container 48, an advance is made to step S6, where that larva sustenance container 48 is transported to the larva rearing section 4, and then an advance is made to step S8. On the other hand, if all the larva sustenance containers 48 have just been replaced and there is no such larva sustenance container 48, a direct advance is made to step S8.

At step S8, it is checked whether or not there is, in the larva rearing section 4, a larva sustenance container 48 that was transported 24 hours or more but less than 48 hours ago. This is because, in such a larva sustenance container 48, first-instar larvae 62 are expected to be present. If there is any such larva sustenance container 48, an advance is made to step S10, where the container transport portion 58 transports it onto the first-instar management portion 60, and then an advance is made to step S12. On the other hand, if there is no such larva sustenance container 48, a direct advance is made to step S12.

Likewise, at step S12, it is checked whether or not there is, in the larva rearing section 4, any larva sustenance container 48 that was transported 48 hours or more but less than 72 hours ago. This is because, in such a larva sustenance container 48, second-instar larvae 66 are expected to be present. If there is any such larva sustenance container 48, an advance is made to step S14, where the container transport portion 58 transports it onto the second-instar management portion 64, and then an advance is made to step S16. On the other hand, if there is no such larva sustenance container 48, a direct advance is made to step S16.

Furthermore, at step S16, it is checked whether or not there is, in the larva rearing section 4, any larva sustenance container 48 that was transported 72 hours or more ago. This is because, in such a larva sustenance container 48, third-instar larvae 70 are expected to be present. If there is any such larva sustenance container 48, an advance is made to step S18, where the container transport portion 58 transports it onto the third-instar management portion 68, and then an advance is made to step S20. On the other hand, if there is no such larva sustenance container 48, a direct advance is made to step S20.

At step S20, based on the results of the detection by the first-instar management portion 60, the second-instar management portion 64, and the third-instar management portion 68, which detect the composition of the contents in the larva sustenance container 48 immediately after its transport at steps S10, S14, and S18 respectively, it is checked whether or not a change in the composition is within the expected, normal range and thus there is no abnormality. If there is no abnormality, an advance is made to step S22, where it is then checked whether or not the composition detected by the third-instar management portion 68 is within a predetermined range. This is equivalent to checking whether or not an expected number of third-instar larvae 70 are present. It should be noted here that, for the check at step S22, to cancel variation ascribable to that in the amount of sustenance etc., the results of the detection by the first-instar management portion 60, the second-instar management portion 64, and the third-instar management portion 68 are subtracted from one another.

If, at step S22, the composition detected by the third-instar management portion 68 is detected to be out of the predetermined range, an advance is made to step S24, where the proportion in which larva sustenance containers 48 containing third-instar larvae 70 are transported to the imago circulation section 8 is adjusted, and then an advance is made to step S26. Specifically, at step S24, if the composition detected by the third-instar management portion 68 is greater than the predetermined range, the distribution proportion to the imago circulation section 8 is decreased; if the composition detected by the third-instar management portion 68 is smaller than the predetermined range, the distribution proportion to the imago circulation section 8 is increased. It should be noted that, if the composition detected by the third-instar management portion 68 is within the predetermined range, no such adjustment is needed, and therefore a direct advance is made to step S26. At step S26, larva sustenance containers 48 containing third-instar larvae 70 are transported from the larva rearing section 4 either to the larva separation section 6 or to the imago circulation section 8 in the set distribution proportions, and an advance is made to step S28. On the other hand, if, at step S16, no larva sustenance container 48 is found in the larva rearing section 4 that was transported 72 hours or more ago and that contains third-instar larvae 70, a direct advance is made to step S28.

Here, a supplementary description will be given of a derivative function of step S22. At step S22, the composition in the third-instar management portion 68 is checked. Even if the result is within the predetermined rage, information on the composition is utilized in the function of a succeeding stage such as the larva anesthetizing/pricking section 10 etc. How this is does will be described later.

At step S28, it is checked whether or not the result of the check by the production checking section 18 is normal. If it is normal, an advance is made to step S30, where permission is given for the crushed larvae 88 in the larva crushing section 16 to be transported to the feed mixing section 20 and mixed with feed 90 as the product. A return is then made to step S4, and thereafter steps S4 through S30 are performed repeatedly; in this way, production control is achieved.

It should be noted that, if, at step S20, an abnormal change in the composition is detected, an advance is made to step S32, where the production is stopped, and the flow ends. This is because the larva rearing section 4 may then have a problem which may discourage the continuation of the production. Also, if, at step S28, the result of the production check is abnormal, indicating that the expected antimicrobial peptide is not being produced, an advance is made to step S32, where the production is stopped, and the flow ends. This is because mixing such crushed larvae 88 makes the production of the feed 90 meaningless.

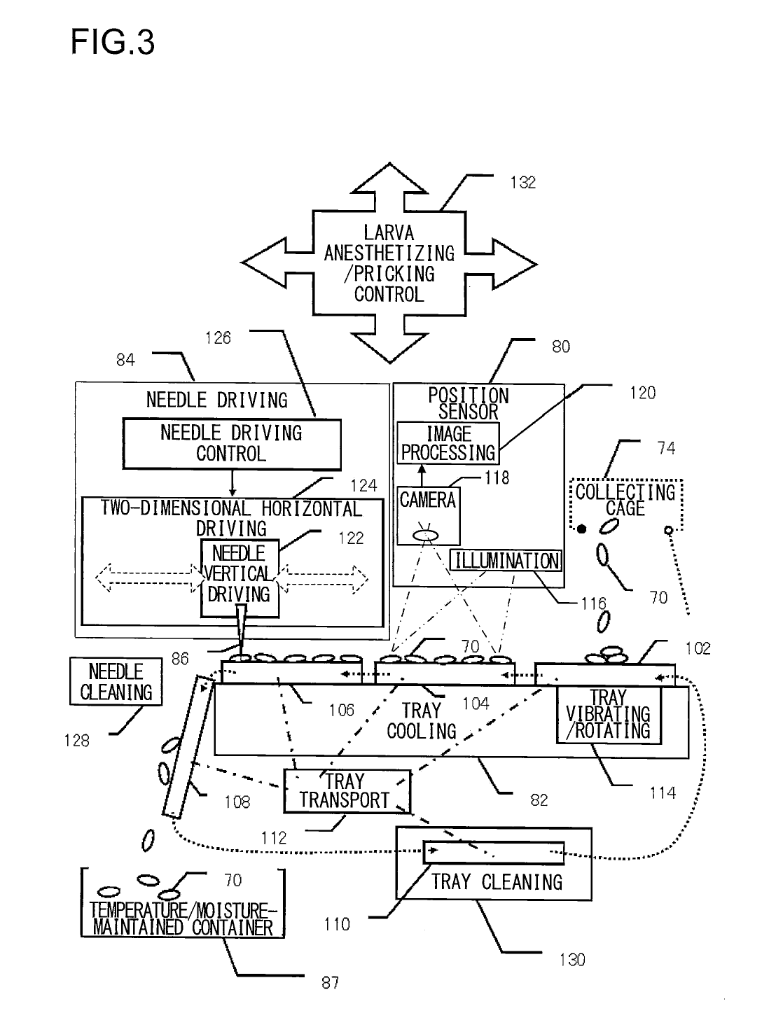

FIG. 3 is a block diagram showing the detailed configuration of the larva anesthetizing/pricking section 10 in Example 1 shown in FIG. 1. Such elements as find their counterparts in FIG. 1 are identified by common reference signs. As shown in FIG. 3, the tray portion 78 divides into a plurality of trays 102, 104, 106, 108, 110, and so fourth, which are transported by a tray transport portion 112 so as to circulate around the tray cooling portion 82. As mentioned previously, each tray is given a black surface and made of a material having a high thermal conductivity, such as metal. When in contact with the tray cooling portion 82, each tray refrigeration-anesthetizes the third-instar larvae 70 placed on it.

The third-instar larvae 70 transported in the collecting cage 74 to the larva anesthetizing/pricking section 10 are then, with the gate of the collecting cage 74 opened, dropped onto the tray 102 located in a vibrating/rotating position. At this time, the third-instar larvae 70 are concentrated in a central part of the tray 102, forming a pile. A tray vibrating/rotating portion 114 vibrates the tray 102, and simultaneously rotates it to give it a gentle centrifugal force, so that the third-instar larvae 70 are spread evenly over the entire tray 102 without overlaps among them. How this is does will be described later.

The tray 102 given predetermined vibration and rotation by the tray vibrating/rotating portion 114 is then transported, by the tray transport portion 112, to a position detecting position, like the tray 104. The cooling of the third-instar larvae 70 starts when a tray, like the tray 102, is located at the tray vibrating/rotating portion 114, and is done in earnest after the tray, like the tray 104, is transported to the position detecting position. The tray 104 transported to the position detecting position is illuminated obliquely by an illumination portion 116 including a flash bulb or the like, and is photographed from right above by a camera portion 118. The photographing is performed repeatedly at predetermined time intervals, each time producing a still image which is then processed at an image processing section 120. At this time, the tray 104 having a black surface allows easy detection of the outlines of the third-instar larvae 70, which are white. The oblique illumination by the illumination portion 116 too allows easy detection of the outlines of the third-instar larvae 70.

The image processing section 120 processes the photographed image to detect, first, whether or not there is an overlap among the third-instar larvae 70 on the tray 104. If any such overlap is detected, the tray transport portion 112 returns the tray 104 to the position of the tray 102. The image processing section 120 also compares still images photographed at the predetermined time intervals so that, when no difference is detected between two consecutive images any longer, it is judged that all the third-instar larvae 70 have been anesthetized and immobilized. In response, the tray transport portion 112 transports the tray 104 to a pricking position, like the tray 106, under the needle driving portion 84. The photographed still images are also used in the needle driving portion 84 as information on the positions of the individual third-instar larvae 70.

The needle 86 is held by a needle vertical driving portion 122, which drives the needle 86 to move down and upward at high speed. The needle vertical driving portion 122 is held by a two-dimensional horizontal driving portion 124. Based on the information on the positions of the individual third-instar larvae 70 as detected by the image processing section 120, a needle driving control portion 126 controls the movement of the needle vertical driving portion 122 and the two-dimensional horizontal driving portion 124. With this configuration, the needle 86 is moved two-dimensionally, as indicated by the broken-line arrow on the right of the needle vertical driving portion 122, to right above one third-instar larva 70 after another to prick the third-instar larvae 70 one by one. The pricking is done so as to largely penetrate the larva, but since the wound closes within a few minutes by the self-healing power, the body fluid does not leak. Moreover, the pricking is done at high speed, and in particular the needle is extracted at so high a speed that the inertia of the mass of the third-instar larva 70 prevents it from being lifted as the needle moves up.

Through a predetermined procedure, the needle driving control portion 126 instructs the two-dimensional horizontal driving portion 124 to move the needle vertical driving portion 122 to above a needle cleaning portion 128 as indicated by the broken-line arrow on the left of the needle vertical driving portion 122, and instructs the needle vertical driving portion 122 to move the needle 86 down and upward a plurality of rounds in the needle cleaning portion 128, with movement in cleaning mode which differs from movement for pricking. Thus, stain such as from the body fluid of the third-instar larvae 70 is cleaned off the needle 86 as necessary. This function of the needle driving control portion 126 will be described in detail later.

When all the third-instar larvae 70 on the tray 106 have been pricked, with a view to moving them to the temperature/moisture-maintained container 87, the antimicrobial peptide production section 12 transports the tray 106 to an ejecting position and tilts it, like the tray 108. The third-instar larvae 70 having been pricked and moved to the temperature/moisture-maintained container 87 are then, along with the container that received them, to the antimicrobial peptide production section 12.

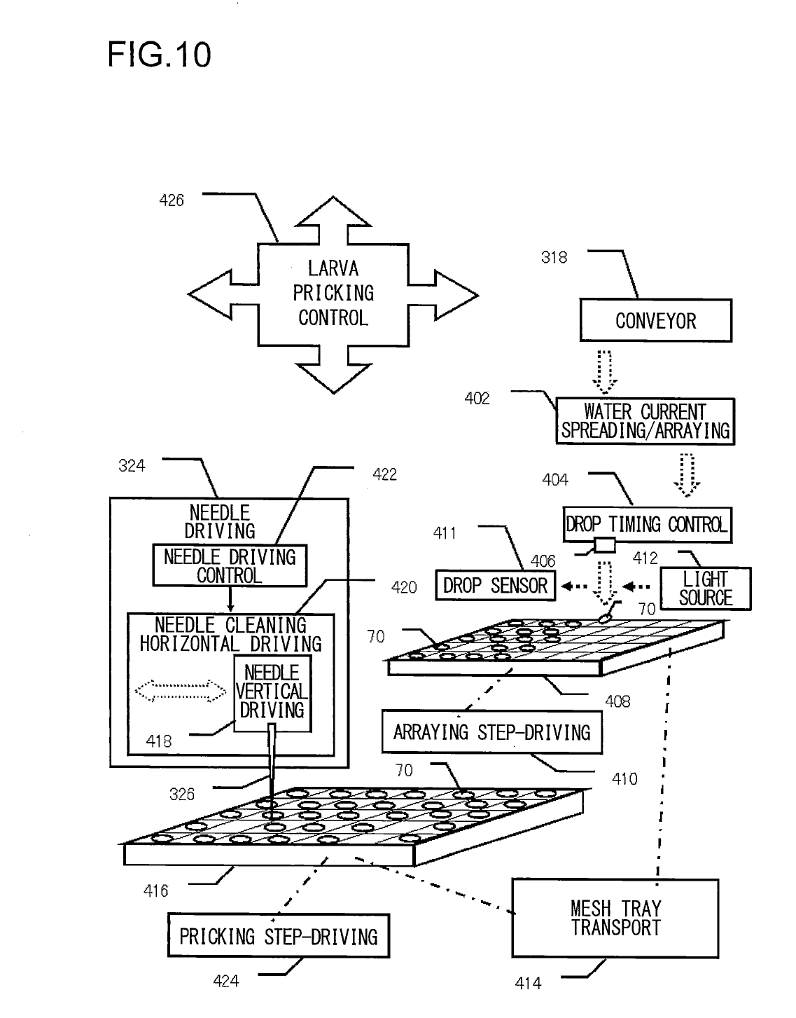

The emptied tray 108 is then moved by the tray transport portion 112 to a cleaning position, like the tray 110, inside a tray cleaning portion 130. There the tray 110 has its surface cleaned. The tray 110 is then transported by the tray transport portion 112 back to the vibrating/rotating position, like the tray 102, where it prepares to receive the next batch of third-instar larvae 70 from the collecting cage 74. The above-described function of different parts shown in FIG. 10 is controlled by a larva anesthetizing/pricking control portion 132, which includes a computer.

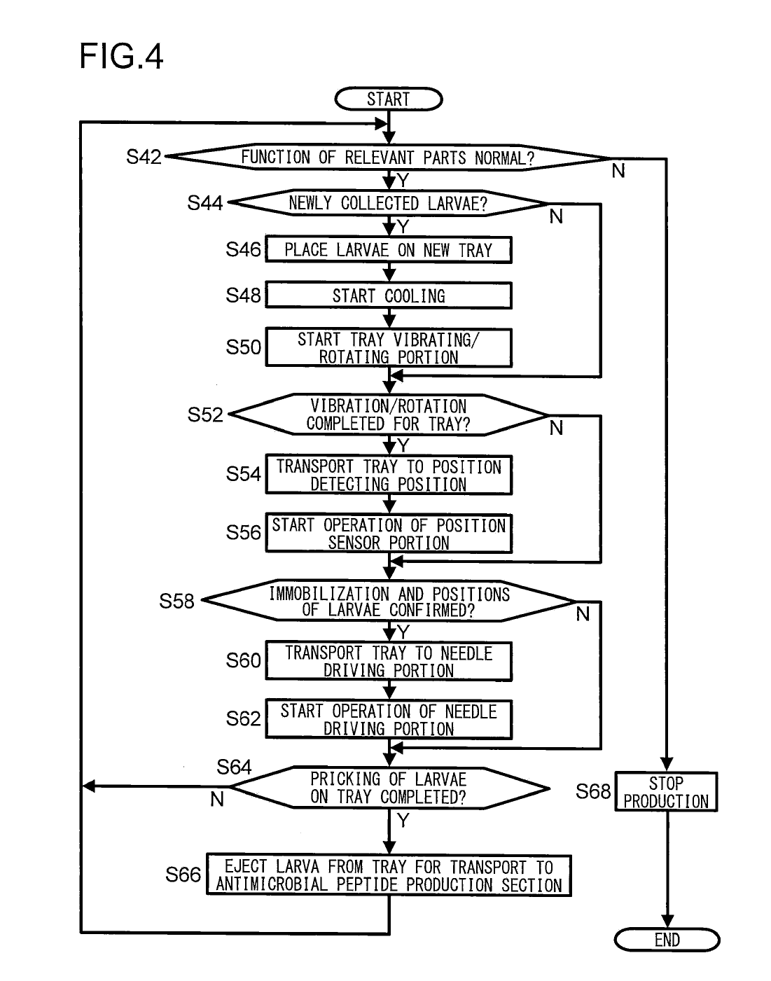

FIG. 4 is a flow chart showing the basic function of the larva anesthetizing/pricking control portion 132 in FIG. 3. The flow starts when, at step S18 in FIG. 2, third-instar larvae 70 are transported to the larva anesthetizing/pricking section 10 for the first time. First, at step S42, the function of the parts involved is checked. If their function is normal, an advance is made to step S44, where a check is made for the presence of newly collected third-instar larvae 70. This is equivalent to checking whether or not the collecting cage 74 transported in FIG. 3 has been set in the larva anesthetizing/pricking section 10 and is ready to be transported to the tray 102.

If newly collected third-instar larvae are ready, an advance is made to step S46, where the third-instar larvae 70 is placed on a new tray 102; then an advance is made to step S48, where the cooling by the tray cooling portion 82 is started. Next, at step S50, the vibrating/rotating operation by the tray vibrating/rotating portion 114 is started, and then an advance is made to step S52. If, at step S44, newly collected third-instar larvae are not ready, a direct advance is made to step S52.

At step S52, it is checked whether or not there is a tray for which the vibrating/rotating operation by the tray vibrating/rotating portion 114 has been completed. If there is any such tray, an advance is made to step S54, where that tray is transported to the position detecting position, like the tray 104 in FIG. 3. Next, at step S56, the operation by the position sensor portion 80 in FIG. 3 is started, and an advance is made to step S58. If, at step S52, no tray is detected for which the vibrating/rotating operation by the tray vibrating/rotating portion 114 has been completed, a direct advance is made to step S58.

At step S58, it is checked whether or not the position sensor portion 80 has confirmed the immobilization of the third-instar larvae 70 and their respective positions. If there is any such tray, i.e. a tray for which the immobilization of the third-instar larvae 70 and their respective positions have been confirmed, an advance is made to step S60, where that tray is transported to the pricking position, like the tray 106 in FIG. 3. Next, at step S62, the operation by the needle driving portion 84 in FIG. 3 is started, and an advance is made to step S64. If, at step S58, the position sensor portion 80 does not confirm the immobilization of the third-instar larvae 70 and their respective positions, a direct advance is made to step S64.

At step S64, it is checked whether or not the pricking of all the third-instar larvae 70 on the tray 106 by the needle driving portion 84 has been completed, and if so, an advance is made to step S66, where the third-instar larvae 70 are ejected from the tray 108 so as to be transported further to the antimicrobial peptide production section 12 as shown in FIG. 3. After the steps described above, a return is made to step S42, and thereafter steps S42 through S66 are performed repeatedly; in this way, the function of the larva anesthetizing/pricking section 10 is controlled. During the repetition just mentioned, if, at step S64, completion of larva pricking is not detected, a direct return is made to step S42. On the other hand, if, at step S42, any abnormality is detected in any of different parts in the larva anesthetizing/pricking section 10, an advance is made to step S68, where the production is stopped and the flow ends.

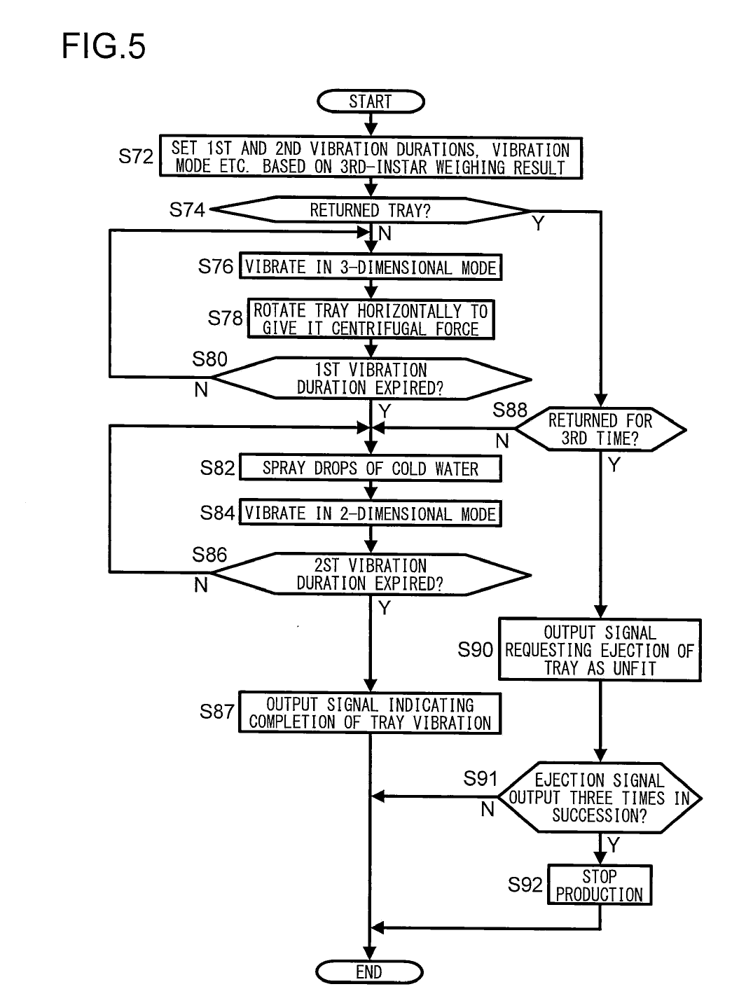

FIG. 5 is a flow chart showing in detail the function of the tray vibrating/rotating portion 114 started at step S50 in FIG. 4, the function being executed by the computer in the larva anesthetizing/pricking control portion 132. When the function of the tray vibrating/rotating portion 114 is started and the flow starts, first, at step S72, details are set, such as a first and a second vibration duration, a vibration mode, etc. These are set based on the information on the composition in the third-instar management portion 68 as obtained at step S22 in FIG. 2. The composition in the third-instar management portion 68 is information that depends on the number of third-instar larvae 70, and it is effective to finely adjust the mode of vibration and rotation for spreading them evenly in accordance with the number of third-instar larvae 70. The setting made at step S72 is for that adjustment. The significance of the first vibration duration etc. will be described in connection with the succeeding steps.

Next, at step S74, it is checked whether or not the tray 102 placed on the tray vibrating/rotating portion 114 is one that has been returned from the position detecting position like the tray 104. If not, this indicates that the tray is one that has newly received third-instar larvae 70 from the collecting cage 74, and accordingly an advance is made to step S76, where vibration is applied in three-dimensional mode, i.e. both horizontally and vertically. Next, at step S78, the tray 102 is rotated so as to be given a centrifugal force, and an advance is made to step S80. At step S80, it is checked whether or not the first vibration duration, for which the vibration and rotation just mentioned are expected to be applied, has expired. If the duration has not expired yet, a return is made to step S76, where, until the duration is detected to have expired, steps S76 through S80 are repeated to continue the vibration in three-dimensional mode and the rotation. As mentioned previously, the degree in which the vertical vibration component is applied at step S76, the degree in which the centrifugal force is applied in step S78, and the first vibration duration checked at step S80 are set at step S72.

If, at step S80, the first vibration duration is detected to have expired, an advance is made to step S82, where drops of cold water at about 4° C., i.e. the cooling temperature, are sprayed onto the tray 102. The aim is to separate the third-instar larvae 70, which are adhered together, from one another. Next, an advance is made to step S84, where vibration is applied in two-dimensional mode, i.e. only horizontally. Then, at step S86, it is checked whether or not the second vibration duration, for which the spray of cool water drops and the vibration just mentioned are expected to be applied, has expired. If the duration has not expired yet, a return is made to step S82, and thereafter, until the duration is detected to have expired, steps S82 through S86 are repeated to continue the spraying of cold water drops and the rotation in two-dimensional mode. Here also, the degree of spraying cold water drops at step S82, the degree of vibration in two-dimensional mode at step S84, and the second vibration duration checked at step S80 are set at step S72.

If, at step S87, the second vibration duration is detected to have expired, an advance is made to step S87, where a signal indicating that the tray vibration has been completed is output and the flow ends. The signal output at step S87 is one needed in the check at step S52 in FIG. 4.

On the other hand, if, at step S74, it is found that the tray 102 placed on the tray vibrating/rotating portion 114 is one returned from the position detecting position like 104, an advance is made to step S88, where it is checked which individual tray that tray is, to check whether or not that tray has been returned for the third time. If the tray has been returned for the second time or less, an advance is made to step S82, so that the steps starting at step S82 are performed. This is because, if the tray is a returned one, it is expected that the third-instar larvae have been spread to some extent and performing the steps starting at step S82 suffices to eliminate overlaps among larvae.

By contrast, if, at step S88, the same tray has been returned three times, an advance is made to step S90, where it is recognized that further vibration will not eliminate overlaps among larvae, and a signal is output that requests that tray to be ejected from the tray transport path. In response, the tray transport portion 112 ejects the tray from the normal transport path, discards the third-instar larvae 70 on that tray, and transports it to the tray cleaning portion 130.

Furthermore, at step S91, it is checked whether or not the ejection signal output at step S90 has been output three times in succession. If it has been output two times or less, it is recognized that these is still no problem, and the flow ends. On the other hand, if, at step S91, the ejection signal has bend detected three times in succession, an advance is made to step S92, where the production is stopped and the flow ends. This is because that means not a fault with an individual tray but a fault with the tray vibrating/rotating portion 114 itself.

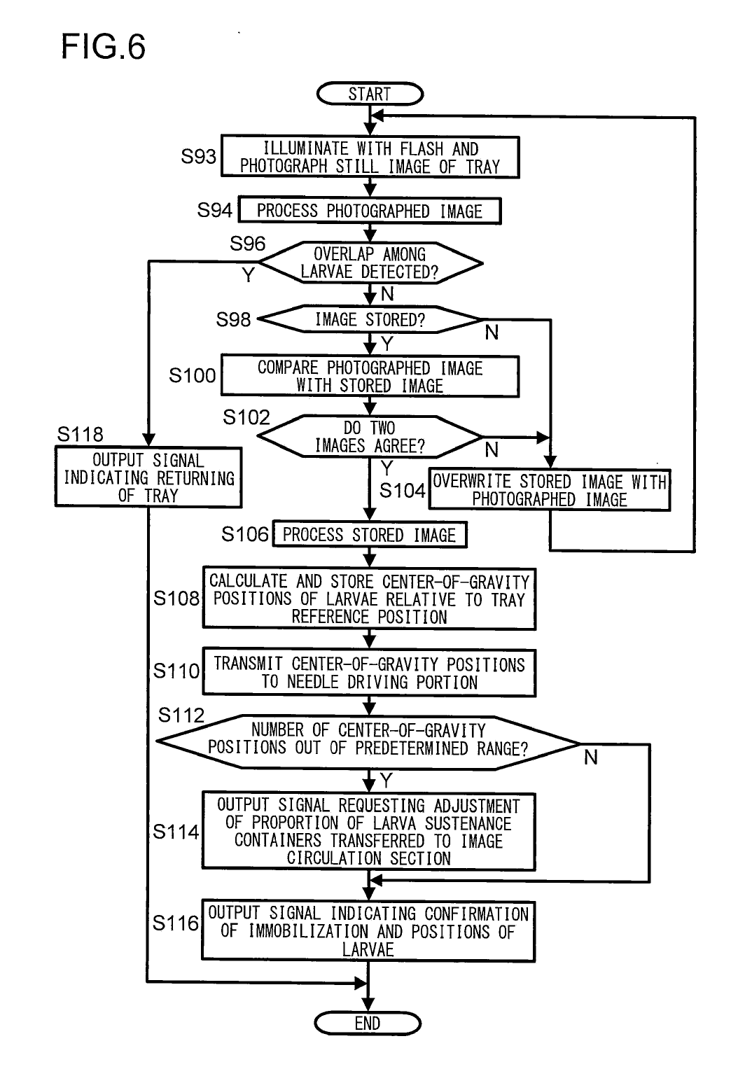

FIG. 6 is a flowchart showing in detail the function of the position sensor portion 80 started at step S56 in FIG. 4, the function being executed by the computer in the larva anesthetizing/pricking control portion 132. When the function of the position sensor portion 80 is started and the flow starts, first, at step S93, under the illumination provided by the light emission by the flash bulb in the illumination portion 116, the camera portion 118 photographs a still image of the tray 104. Next, at step S94, the image processing section 120 processes the photographed image, and then an advance is made to step S96.

At step S96, based on the result of the image processing, it is checked whether or not there is an overlap among larvae. If there is no overlap, an advance is made to step S98, where it is checked whether or not a previously photographed image is stored. If there is a stored image, an advance is made to step S100, where that image is compared with the image photographed this time. Next, an advance is made to step S102, where it is checked whether or not the comparison result indicates agreement between the two images.

At an initial stage of cooling when anesthesia is insufficient, the third-instar larvae 70 move on the tray 104, producing a disagreeing comparison result; thus, an advance is made to step S104. Then, the stored image is overwritten with the image photographed this time, and a return is made to step S93. If, at step S98, there is no stored image, this means that the image just photographed is the first, and thus a direct advance is made to step S104. Although in this case there is no older image that is going to be overwritten, what is done at step S104, i.e. just storing the image photographed this time, is generally called “overwriting.” Thereafter, until refrigeration anesthesia immobilizes all the third-instar larvae 70 on the tray 104, steps S93 through 5104 are repeated.

On the other hand, when anesthesia is sufficient, and thus the two images are detected to agree at step S102, then an advance is made to step S106, where the image processing section 120 processes the stored image. Next, at step S108, based on the result of the image processing, the center-of-gravity positions of the two-dimensional images of individual third-instar larvae 70 are calculated, and these are stored as information on the two-dimensional positions of the third-instar larvae 70 relative to a reference position on the tray 104. At this time, adopted as the reference position on the tray 104 may be an image of an edge of the tray 104 or an image of an alignment mark previously put on the tray 104.

Next, at step S110, the stored center-of-gravity positions of the individual third-instar larvae 70 are transmitted to the needle driving portion 84. The information on the center-of-gravity positions also serves as information on the accurate number of third-instar larvae 70 on the tray 104, and therefore, at step S112, it is checked whether or not the number is out of a predetermined range. If it is out of the predetermined range, an advance is made to step S114, where, as in step S24 in FIG. 2, a signal for adjusting the distribution proportion of larva sustenance containers 48 to be transported to the imago circulation section 8 is output, and then an advance is made to step S116. If, at step S112, the number of center-of-gravity positions is within the predetermined rage, a direct advance is made to step S116. The signal output at step S114 is used in the production control portion 22 in FIG. 1.

Next, at step S116, a signal indicating the confirmation of the immobilization of larvae and the confirmation of the positions of individual larvae is output, and the flow ends. The signal output at step S116 is used in the check at step S58 in FIG. 4. On the other hand, if, at step S96, an overlap among larvae is detected, an advance is made to step S118, where a signal indicating the returning of a tray is output, and the flow ends.

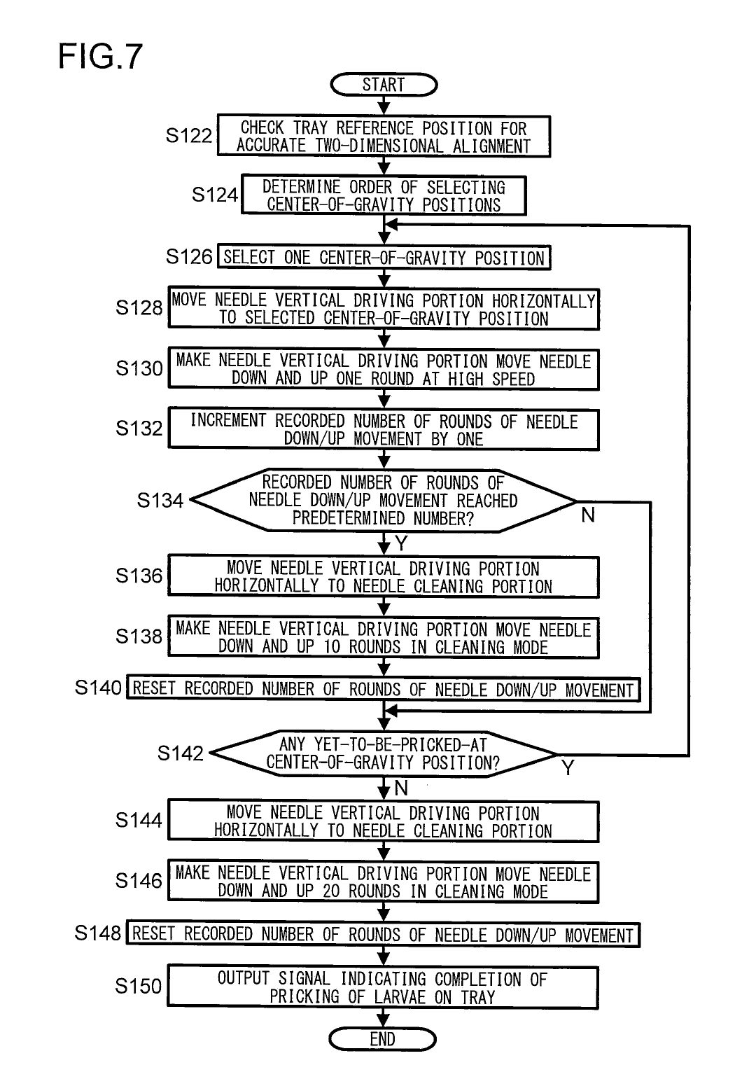

FIG. 7 is a flow chart showing in detail the function of the needle driving portion 84 started at step S62 in FIG. 4, the function being executed by the computer in the larva anesthetizing/pricking control portion 132. When the function of the needle driving portion 84 is started, first, at step S122, the reference position on the tray 106 transported in is checked for accurate two-dimensional alignment to see whether or not the tray 106 is set at a proper position with respect to the needle driving portion 84. This can be achieved by checking whether or not an edge or the like of the tray 106 is in proper contact with a reference stopper provided on the needle driving portion 84.

Next, at step S124, based on the center-of-gravity positions of the individual third-instar larvae 70 as transmitted from the position sensor portion 80, the order in which to select them one after another is determined. The order is determined with consideration given to the relationship of the center-of-gravity positions relative to one another such that the needle 86 efficiently moves among neighboring center-of-gravity positions. Thereafter, an advance is made to step S126, where, in accordance with the order so determined, one center-of-gravity position is newly selected as the one of the highest priority.

Next, at step S128, the two-dimensional horizontal driving portion 124 moves the needle vertical driving portion 122 horizontally so that the needle 86 comes right above the selected center-of-gravity position. When the movement is found to be completed, an advance is made to step S130, where the needle vertical driving portion 122 moves the needle 86 down and upward one round at high speed. Thus, the third-instar larva 70 located right below is pricked. Next, at step S132, the recorded number of rounds of needle down/up movement is incremented by one, and an advance is made to step S134. Needless to say, immediately after the first pricking, step S132 yields “one” as the recorded number of rounds of needle down/up movement.

At step S134, it is checked whether or not the recorded number of rounds of needle down/up movement has reached a predetermined number. If so, an advance is made to step S136, where the two-dimensional horizontal driving portion 124 moves the needle vertical driving portion 122 so that the needle 86 comes right above the needle cleaning portion 128. When the movement is found to be completed, an advance is made to step S138, where the needle vertical driving portion 122 moves the needle 86 down an up ten rounds in cleaning mode. For effective cleaning, the down/up movement of the needle 86 in cleaning mode differs from that for pricking. Moreover, in cleaning mode, as necessary, the two-dimensional horizontal driving portion 124 may additionally apply slight horizontal movement. Next, at step S140, the recorded number of rounds of needle down/up movement is reset to zero, and an advance is made to step S142. If, at step S134, the recorded number of rounds of needle down/up movement is not found to have reached the predetermined numbers, a direct advance is made to step S142. In the manner described above, each time pricking has been done a predetermined number of rounds, the needle 86 is cleaned in the needle cleaning portion 128.

At step S142, it is checked whether or not there still remains a yet-to-be-pricked-at center-of-gravity position at which pricking has not been done yet. If there is any yet-to-be-pricked-at one, a return is made to step S126, where the next one center-of-gravity position is selected. Thereafter, in a similar manner, until the needle 86 has been moved down and up at all the center-of-gravity positions, steps S126 through S142 are repeated.

On the other hand, if, at step S142, no yet-to-be-pricked-at center-of-gravity position is found, an advance is made to step S144, where the two-dimensional horizontal driving portion 124 moves the needle vertical driving portion 122 horizontally so that the needle 86 comes right above the needle cleaning portion 128. When the movement is found to be completed, an advance is made to step S146, where the needle vertical driving portion 122 moves the needle 86 down and up 20 rounds in cleaning mode. Whereas at step S138, when pricking is still underway, the number of rounds that the needle 86 is moved down and up in cleaning mode is kept minimal to give priority to quick completion of the pricking, at step S146, when all pricking has been completed, priority is given to thorough cleaning. Next, at step S148, the recorded number of rounds of needle down/up movement is reset to zero in preparation for pricking in a new tray. Next an advance is made to step S150, where a signal indicating the completion of the pricking of all the third-instar larvae 70 on the tray 106 is output. This signal is used in the check at step S64 in FIG. 4.

Although Example 1 described above deals with a case where the production of an antimicrobial peptide is achieved by the pricking of larvae, this is not meant to limit even part of the features of the invention; the invention is applicable equally in cases where a larva is made to generate an antimicrobial peptide by any other method. For example, feed containing an antimicrobial peptide according to the invention may also be produced using an antimicrobial peptide produced by flesh-flies that are phenotypically transformed by genetic modification or the like so as to express an antimicrobial peptide in large amounts. Moreover, instead of, with priority given to mass production and reduced cost, mixing the antimicrobial peptide in the feed by crushing whole larvae as in Example 1, it is also possible, with priority given to purity, to extract the body fluid of the larvae and mix it in the feed. Moreover, since an antimicrobial peptide is not denatured on heating, instead of freeze-drying the larvae as in Example 1, it is also possible to dry them by heating.

Likewise, the different features of the production control in Example 1 described above also are applicable not only in cases where the production of an antimicrobial peptide is achieved by the pricking of larvae, but also in cases relying on flesh-flies that are phenotypically transformed by genetic modification or the like so as to express an antimicrobial peptide in large amounts as mentioned above.

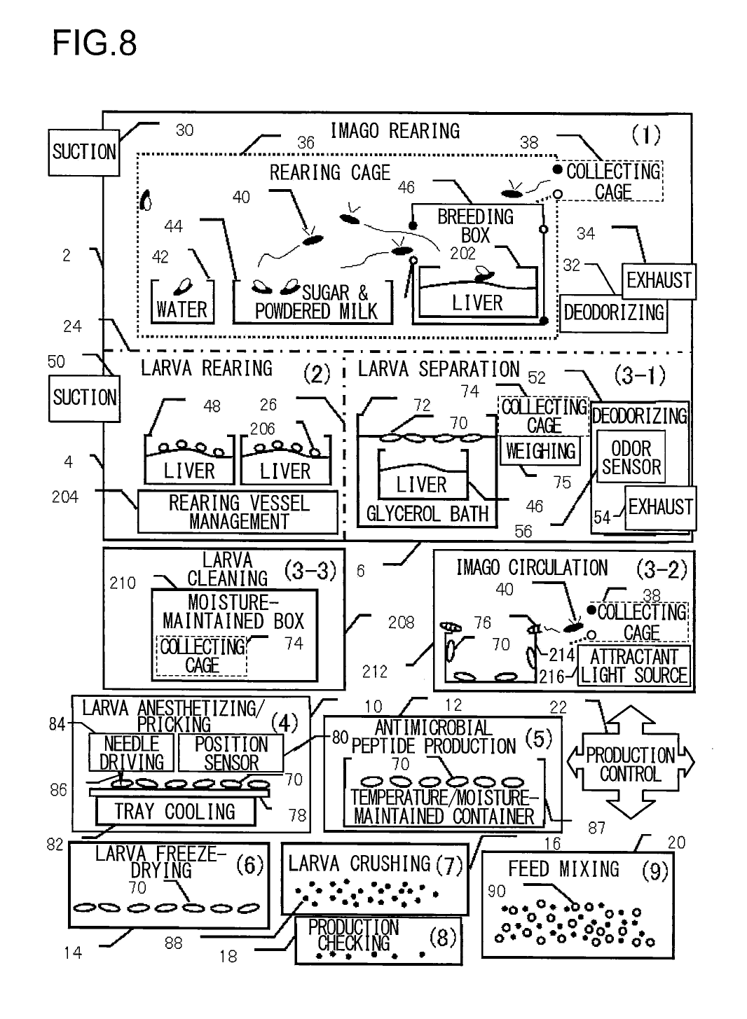

FIG. 8 is a block diagram of a feed production system using flesh-flies, as a second example (Example 2) embodying the present invention. The configuration here has many in common with that of Example 1 in FIG. 1; accordingly, such parts as are common to the two examples are identified by common reference signs, and no overlapping description will be repeated unless necessary. As with Example 1, the parenthesized numbers, (1) to (9), indicate the order in which different processes are performed at the relevant parts.

In Example 2, in the breeding box 46, a breeding-dedicated sustenance box 202 is provided, and by inspecting the color of the surface there, it is recognized whether or not a predetermined number of young have been delivered. For that purpose, the breeding box 46 is provided with a camera or sensor for inspecting the surface in the breeding-dedicated sustenance box 202, and based on information from it, the production control portion 22, through image analysis or color analysis of the surface in the breeding-dedicated sustenance box 202, checks whether or not a sufficient number of young are present.

When it is confirmed that a sufficient number of young have been delivered in it, the breeding-dedicated sustenance box 202 is automatically taken out of the breeding box 46 under the control of the production control portion 22. It is then stirred to make the composition inside the breeding-dedicated sustenance box 202 even, and then its contents are divided among larva sustenance containers 48, which are then automatically transported to the larva rearing section 4. Consequently, the larva sustenance containers 48 that are divided from the same breeding-dedicated sustenance box 202 and transported to the larva rearing section 4 contain largely equal numbers of larvae.

For each larva sustenance container 48 transported to the larva rearing section 4, a rearing vessel management portion 204 manages the time that has passed since the transport took place. Although FIG. 8 shows larvae of the same size as representative, in reality, depending on the time that has passed after transport, some larva sustenance container 48 contain first-instar larvae 62, some other contain second-instar larvae 66, and some other contain third-instar larvae 70. For each of these, the rearing vessel management portion 204 manages the time passed after transport. The rearing vessel management portion 204 is further provided with an unillustrated larva creep sensor. Detecting larvae creeping up a larva sustenance container 48 containing third-instar larvae 70 makes it possible to recognize that the third-instar larvae 70 in that larva sustenance container 48 have matured completely.

For the purpose of preventing larvae creeping up from falling directly into the larva rearing section 4, and for the purpose of surely detecting larvae having started to creep up, each larva sustenance container 48 may be given a double construction by being housed inside an unillustrated escape prevention cage and then placed inside the larva rearing section 4 so that, by detecting larvae starting to fall into the escape prevention cage, it is recognized that the third-instar larvae 70 have matured completely.

The larva separation section 6, though shown arranged differently than in FIG. 1, is configured similarly as in Example 1. Here, however, the suction portion 50 and the deodorizing portion 52 are shared between the larva rearing section 4 and the larva separation section 6. A larva cleaning portion 208 is an illustrated representation of what has already been described in connection with Example 1; it has a collecting cage 74 housed inside a moisture-maintained box 210, and keeps larvae in maintained moisture for 24 hours to let them digest the residual sustenance in their body. As mentioned previously, the progress of larva cleaning can be checked by inspecting them from outside, and accordingly the larva cleaning portion 208 is provided with a sensor for inspecting an image or color of larvae for automatic checking of the progress of cleaning. The larvae, when the residual sustenance in their body is confirmed to have been digested, are then cleaned along with the collecting cage 74, so that excrement etc. are removed from the surface of the bodies of the larvae. In this way, the larvae are cleaned, and thus even when they are, as they are, mixed in feed, the feed is saved from contamination. It should be noted that, in Example 2, not all the larvae in the collecting cage 74 are transported to the larva cleaning portion 208, but in accordance with the distribution proportion to an imago circulation section 212, only part of them are transported to the imago circulation section 212.

In Example 2, distribution is performed not in distribution proportions by the unit of the larva sustenance container 48 as in Example 1; instead, as described above, the larvae separated from each larva sustenance container 48 are distributed either to the larva cleaning portion 208 or to the imago circulation section 212 in predetermined proportions. The third-instar larvae 70 distributed to the imago circulation section 212 are kept in an emergence box 214, where they dry and grow into pupae. The emergence box 214 contains no substance that causes bad odor, such as liver, and therefore it is not provided with a suction portion or an exhaust portion. In FIG. 8, an attractant light source 216 as described in connection with Example 1 is illustrated.

In cases where the residual sustenance in the bodies of the third-instar larvae 70 is expected to be satisfactorily digested while they are kept in the antimicrobial peptide production section 12, their keeping in the larva cleaning portion 208 may be omitted or simplified. This is because, so long as the residual sustenance in the larva bodies is digested at least before the completion of the production of the antimicrobial peptide and the surface of the larva bodies are cleaned again immediately before transport to the larva freeze-drying section 14, the feed 90 can be saved from contamination with the residual sustenance in the larva bodies or the excrement from the larvae. It should however be noted that the omission of the keeping of larvae in the larva cleaning portion 208, or the simplification of the configuration for such keeping, or the shortening of the duration of the keeping should be adopted on the condition that the residual sustenance in the larva bodies does not adversely affect the pricking of the larvae at the larva anesthetizing/pricking section 10 or the production of the antimicrobial peptide at the antimicrobial peptide production section 12.

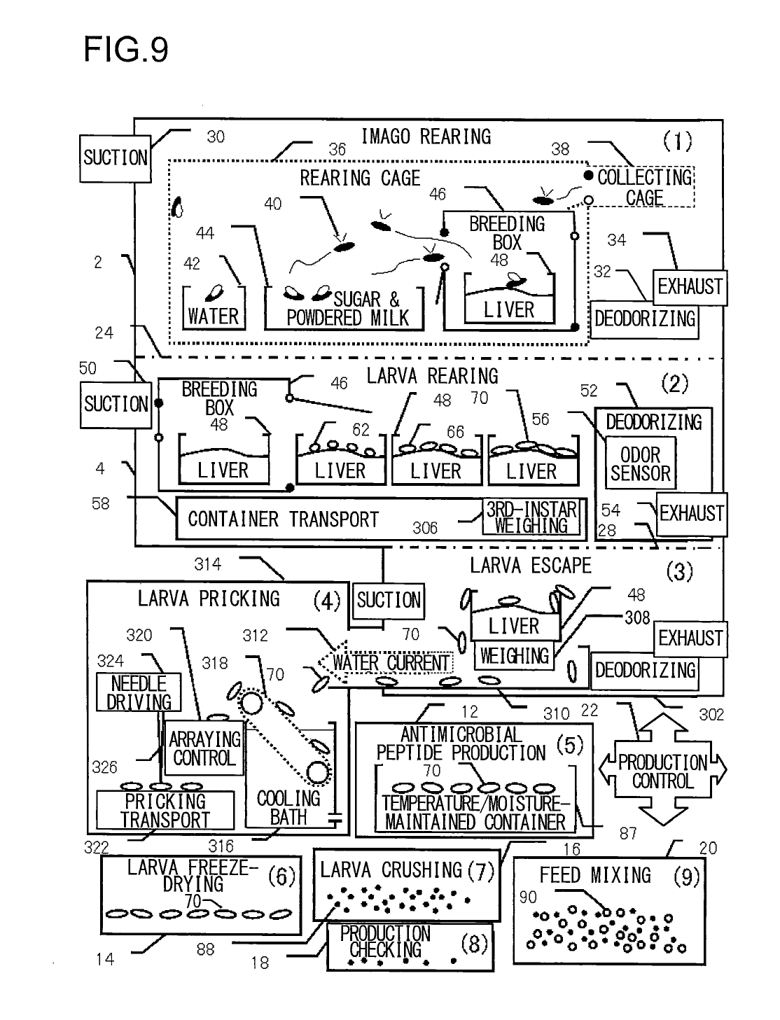

FIG. 9 is a block diagram of a feed production system using flesh-flies, as a third example (Example 3) embodying the present invention. The configuration here has many in common with that of Example 1 in FIG. 1; accordingly, such parts as are common to the two examples are identified by common reference signs, and no overlapping description will be repeated unless necessary. As with Example 1, the parenthesized numbers, (1) to (9), indicate the order in which different processes are performed at the relevant parts.

Example 3 shown in FIG. 9 has sections similar to the imago rearing section 2, the larva rearing section 4, the imago circulation section 8, the antimicrobial peptide production section 12, the larva freeze-drying section 14, the larva crushing section 16, the production checking section 18, and the feed mixing section 20 in Example 1 shown in FIG. 1. In FIG. 9, however, the imago circulation section 8 is omitted from illustration. Example 3 shown in FIG. 9 differs from the other examples in the parts related to the processes from the separation of larvae to the pricking of larvae.

First, with respect to the separation of the third-instar larvae 70, whereas in Examples 1 and 2 the glycerol bath 72 is used, in Example 3 shown in FIG. 9, the creeping of the third-instar larvae 70 themselves up and out of the larva sustenance container 48 is exploited. This simultaneously achieves the separation of the third-instar larvae 70 and the check of whether or not they have completely matured. For these purposes, a larva escape portion 302 is provided.

In Example 3, a larva sustenance container 48 containing larvae 70 that have grown into the third instar has its weight measured at a third-instar weighing portion 306, and is then taken out of the larva rearing section 4 to be placed on a weighing portion 308 inside the larva escape portion 302. Completely matured third-instar larvae 70 creep up the inner wall of the larva sustenance container 48 and reach its top end; the outer wall of the larva sustenance container 48, however, has a surface so treated as to have low adhesion to the third-instar larvae 70, and thus causes any larva which moves to the outer wall to fall into a water current passage 310. The fall of larvae may be prompted by, instead of the surface treatment of the larva sustenance container 48, adopting a container shape expanding outward at the top end, like that of a beaker; this too achieves low adhesion to larvae that have moved to the outer wall. In this way, the third-instar larvae 70 escape one after another from the larva sustenance container 48, and as a result the weight of the larva sustenance container 48 as indicated by the weighing portion 308 gradually decreases from that measured at the third-instar weighing portion 306. When the weight difference detected by the weighing portion 308 has become equal to or more than a predetermined value, the completion of the escape of the third-instar larvae 70 from the larva sustenance container 48 is recognized. Needless to say, the weight difference varies with the variation in the number of third-instar larvae 70 that are originally present in the larva sustenance container 48; even so, by monitoring the rate of change in the weight difference and detecting its reaching saturation, it is possible to recognize the completion of the escape. In a case where the weight of the larva sustenance container 48 is regarded as equal between when it is taken out of the larva rearing section 4 and when it is placed in the larva escape portion 302, the third-instar weighing portion 306 may be omitted.

The water current passage 310 is supplied with a water current 312 in the direction indicated by the arrow, and thus the larvae that have fallen into the water current passage 310 are carried, in a state floating, on the water current 312 until they fall along with the water current 312 into a cooling bath 316 in a larva pricking section 314. The water current 312 is a current of cold water at about 4° C. Thus, as soon as the third-instar larvae 70 fall into the water current passage 310, they start to be cooled, and are kept being cooled inside the cooling bath 316. The water level in the cooling bath 316 is kept constant by the balance between the inflow of the water current 312 and the outflow of water out of the cooling bath 316. The water current 312 thus serves to transport and cool the third-instar larvae 70, and in addition also serves to clean the third-instar larvae 70.

A conveyor portion 318 includes a meshed conveyor belt that exerts high adhesion to the third-instar larvae 70, and as this conveyor belt rotates, the third-instar larvae 70 are taken out of the cooling bath 316 and drained of water, and are moved to an arraying control portion 320. The arraying control portion 320 separates the cooled and cleaned third-instar larvae 70 from one another and arrays them for pricking. The third-instar larvae 70 arrayed by the arraying control portion 320 are then transported stepwise from one to the next by a pricking transport portion 322, so as to be pricked one after another by a needle 326 driven by a needle driving portion 324 to move down and up at high speed. The arraying control portion 320, the pricking transport portion 322, and the needle driving portion 324 will be described in detail later.

FIG. 10 is a block diagram showing in detail the larva pricking section 314, and shows a specific configuration of, mainly, the arraying control portion 320, the pricking transport portion 322, and the needle driving portion 324 along with the conveyor portion 318. A water current spreading/arraying portion 402 is for spreading the third-instar larvae 70 that fall from the conveyor portion 318 to array them in a row, and has a water passage that becomes increasingly narrow from where the falling third-instar larvae 70 are collected. To prevent a clogging with third-instar larvae 70, however, even at its exit part where it is narrowest, the water passage is given a minimum cross-sectional diameter that is sufficiently larger than the size of the third-instar larvae 70. Thus, the water current becomes increasingly fast from where the falling third-instar larvae 70 are collected, and along the water current, the third-instar larvae 70 are spread so as to flow dispersed one by one. The water passage in the water current spreading/arraying portion 402 is bent as necessary along its course to separate the third-instar larvae 70 from one another to prompt their spreading.

After passing through the water current spreading/arraying portion 402 described above, the third-instar larvae 70 are let to fall one by one into a drop timing control portion 404. The drop timing control portion 404 drains the third-instar larvae 70 of water, and drops them down one by one through a drop opening 406. How it operates will be described in detail later. Under the drop opening 406 is provided a mesh tray 408 having a meshed larva placement portion, and an arraying step-driving portion 410 moves it stepwise, one mesh aperture at a time, so that one mesh aperture after another comes right below the drop opening 406. This movement is possible under the presupposition that the positional relationship is previously known between the center of the drop opening 406 and the center of each mesh aperture of the mesh tray 408 as observed when the mesh tray 408 is placed properly in the arraying step-driving portion 410. That is, as a result of the arraying step-driving portion 410 moving the mesh tray 408 stepwise in accordance with information on that positional relationship, the center of one mesh aperture after another comes under the drop opening 406.

A drop sensor 411 and a light source 412 together form an optical coupler, which detects a third-instar larva 70 falling between them from the drop opening 106 onto the mesh tray 408. The arraying step-driving portion 410 moves the mesh tray 408 stepwise in accordance with the detection of the fall of a third-instar larva 70 by the drop sensor 411. Each mesh aperture of the mesh tray 408 has a gentle concavity. This concavity has its surface so treated as to have low adhesion to the third-instar larvae 70; thus, a third-instar larva 70 that has fallen onto it spontaneously comes to the center of the mesh aperture, and is, even if not anesthetized to be completely immobilized, prevented from moving off the center of the mesh aperture.

As will be described later, the arraying step-driving portion 410 moves the mesh tray 408 stepwise also at the lapse of a predetermined time even if no fall of a third-instar larva 70 is detected. This is to avoid a situation in which, while the mesh tray 408 remains placed on the arraying step-driving portion 410 for a long time waiting for the drop of the next third-instar larva 70, the third-instar larvae 70 that have already fallen resume activity and creep out of the mesh, and thereby to quickly complete the arraying of the third-instar larvae 70 on the mesh tray 408. As a result of this configuration, as illustrated, some mesh apertures of the mesh tray 408 may remain unfilled with a third-instar larva 70. The positions of such blank mesh apertures are recorded. The configuration described above corresponds to the details of the arraying control portion 320.

Moved to the last mesh aperture by the arraying step-driving portion 410, the mesh tray 408 is then transported, by a mesh tray transport portion 414, to the position of a mesh tray 416 under the needle driving portion 324. The mesh tray transport portion 414 is similar to the tray transport portion 112 in FIG. 3, and transports the mesh tray 408 further to the antimicrobial peptide production section 12 so that the pricked third-instar larvae 70 are moved into the temperature/moisture-maintained container 87. The mesh tray transport portion 414 transports the mesh tray 408 further to a cleaning portion similar to the tray cleaning portion 130 in FIG. 3, and then circulates it back to the position under the drop opening 406. In FIG. 10, the movement of the third-instar larvae 70 into the temperature/moisture-maintained container 87 and the cleaning of the mesh tray are omitted from illustration.

The configuration of the needle driving portion 324 is simpler than in FIG. 3: for ordinary pricking of larvae, the needle 326 is not moved horizontally but is simply moved down and upward by the needle vertical driving portion 418. For needle cleaning, however, a needle cleaning horizontal driving portion 420 moves the needle vertical driving portion horizontally to over a needle cleaning portion (unillustrated) similar to the needle cleaning portion 128 in FIG. 3. All this driving is controlled by a needle driving control portion 422.

In Example 3, instead of the needle 326 being moved horizontally, the mesh tray 416 is moved stepwise, one mesh aperture at a time, by a pricking step-driving portion 424, and thereby the positional relationship between the needle 326 and the third-instar larvae 70 is changed. This is possible under the presupposition that the positional relationship is previously known between the needle 326 and the center of each mesh aperture of the mesh tray 416 as observed when the mesh tray 416 is placed properly in the pricking step-driving portion 424. That is, as the pricking step-driving portion 424 moves the mesh tray 416 stepwise in accordance with information on that positional relationship, the third-instar larva 70 placed in one mesh aperture after another comes under the needle 326. As mentioned above, information on the positions of the blank mesh apertures where no third-instar larva 70 is present is previously recorded; over those mesh apertures, the needle 326 is not moved down and upward but movement to the next mesh aperture immediately takes place. The configuration for moving the mesh tray 416 described above corresponds to the details of the pricking transport portion 322. A larva pricking control portion 426 controls the entire function of the larva pricking section 314 centered around the arraying control portion 320 and the pricking transport portion 322 described above.

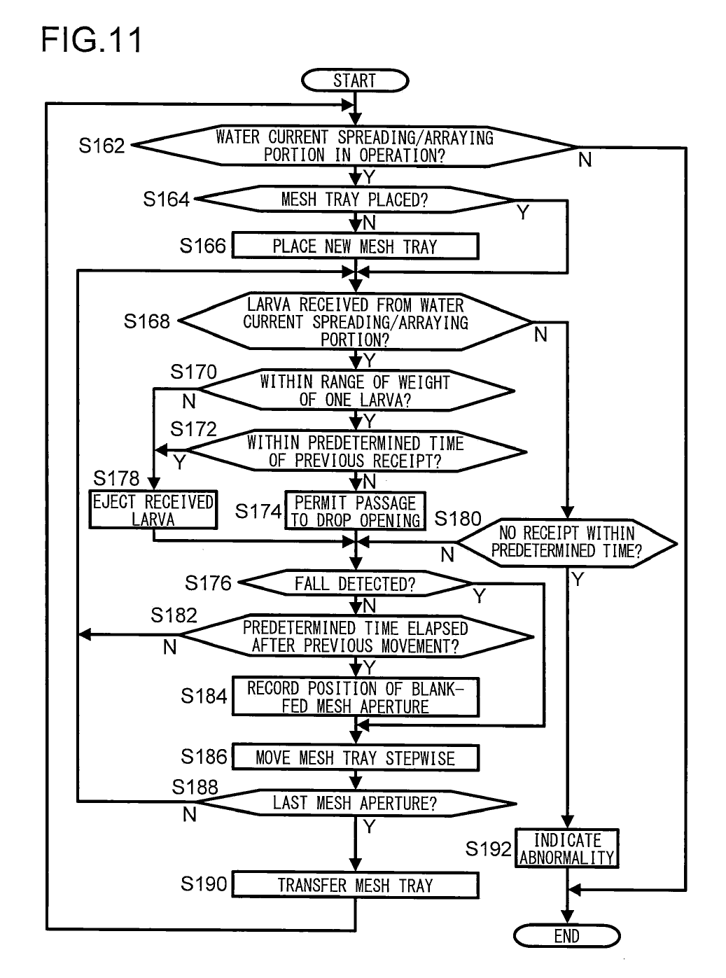

FIG. 11 is a flow chart showing the function of the larva pricking control portion 426 in FIG. 10, and mainly relates to the control of the arraying control portion 320. The flow starts when the water current 312 starts to flow into the cooling bath 316. First, at step S162, it is checked whether or not the water current spreading/arraying portion 402 in the arraying control portion 320 is in operation. If it is in operation, an advance is made to step S164, where it is checked whether or not a mesh tray 408 is placed in the arraying step-driving portion 410. If not, an advance is made to step S166, where the mesh tray transport portion 414 is instructed to place a new mesh tray 408 in the arraying step-driving portion 410, and then an advance is made to step S168. On the other hand, if a mesh tray 408 is already placed, then a direct advance is made from step S164 to step S168.

At step S168, it is checked whether or not the drop timing control portion 404 has received a third-instar larva 70 from the water current spreading/arraying portion 402. If so, an advance is made to step S170, where it is checked whether or not the weight of the received third-instar larva 70 is within an expected range for the weight of a single larva. If it is within the range, an advance is made to step S172, where it is checked whether or not the receipt is within a predetermined time (for example, 2 seconds) of the previous receipt of a third-instar larva. If the receipt is not within the predetermined time but after a sufficient time interval, then an advance is made to step S174, where the received third-instar larva 70 is permitted to pass toward the drop opening 406, and an advance is made to step S176.

On the other hand, if, at step S170, the weight is detected to be out of the expected range, an advance is made to step S178, where the received third-instar larva 70 is ejected and discarded from the drop timing control portion 404, and an advance is made to step S176. This is because a weight smaller than the expected range may mean an abnormal larva, such as broken; on the other hand, a weight greater than the expected range may mean receipt of two or more larvae, which makes it impossible to place one larva in each mesh aperture.

Also if, at step S172, a third-instar larva 70 is detected to have been received in succession within the predetermined time of the previous receipt, an advance is made to step S178, where the received third-instar larva 70 is ejected and discarded from the drop timing control portion 404, and an advance is made to step S176. This is because, if the drop timing control portion 404 receives third-instar larvae 70 in succession at a short time interval, the timing with which the third-instar larvae 70 are dropped one by one through the drop opening 406 does not match the timing with which the arraying step-driving portion 410 moves the mesh tray 408 stepwise, possibly making it impossible to properly array one larva in one mesh aperture.

If, at step S168, the water current spreading/arraying portion 402 does not detect receipt of a larva, then an advance is made to step S180, where it is checked whether or not a predetermined time (for example, 15 seconds) has passed without receiving a third-instar larva 70. If not, an ordinary wait for receipt is still lasting, and therefore an advance is made to step S176.

At step S176, it is checked whether or not the drop sensor 411 has detected a third-instar larva 70 falling from the drop opening 406 to the tray 108. If no fall of a larva is detected, an advance is made to step S182, where it is checked whether or not whether or not a predetermined time (for example, 5 seconds) has elapsed since the mesh tray 408 was moved the previous time. Here, the “previous movement” may be movement for placing a new mesh tray 408 or stepwise movement of an already placed mesh tray 408. If, at step S182, the predetermined time is detected to have elapsed, an advance is made to step S184, where the mesh aperture located under the drop opening 406 at the moment is recorded as a “blank-fed mesh aperture.” Then, an advance is made to step S186, where an instruction is given to move the mesh tray 408 stepwise. In this case, “blank feeding” is effected with no third-instar larva 70 placed in the mesh aperture.

By contrast, if, at step S176, a third-instar larva 70 is detected to have fallen from the drop opening 406 onto the mesh tray 408, a direct advance is made to step S186, where an instruction is given to move the mesh tray 408 stepwise. In this case, ordinary stepwise movement is effected with a third-instar larva 70 placed in the mesh aperture.

Next, at step S188, it is checked whether or not the mesh aperture to which stepwise movement has been effected is the last mesh aperture. If not, a return is made to step S168, where receipt of a larva from the water current spreading/arraying portion 402 is waited for. Also if, at step S182, the lapse of the predetermined time from the previous movement is not detected, a return is made to step S168. Thereafter, unless either the last mesh aperture is detected at step S188 or the lapse of the predetermined time without receipt of a larva is detected at step S180, steps S168 through S188 are repeated, and thus the arraying of the third-instar larvae 70 on the mesh tray 408 progresses.

On the other hand, if, at step S188, the last mesh aperture is detected, then an advance is made to step S190, where the mesh tray transport portion 414 is instructed to move the mesh tray 408 to the position of the mesh tray 416. Then a return is made to step S162. Hereafter, unless either the water current spreading/arraying portion 402 is detected not to be in operation any longer at step S162 or the lapse of the predetermined time without receipt of a larva is detected at step S180, steps S162 through S190 are repeated, and thus the placement of a new mesh tray 408 and the arraying of third-instar larvae 70 on the mesh tray 408 are repeated.

If, at step S162, the water current spreading/arraying portion 402 is detected not to be in operation any longer, the flow in FIG. 11 immediately ends. If, at step S180, the lapse of the predetermined time without receipt of a larva is detected, an advance is made to step S192, where an indication that an abnormality is present at a stage preceding the water current spreading/arraying portion 402 is given, and the flow ends.

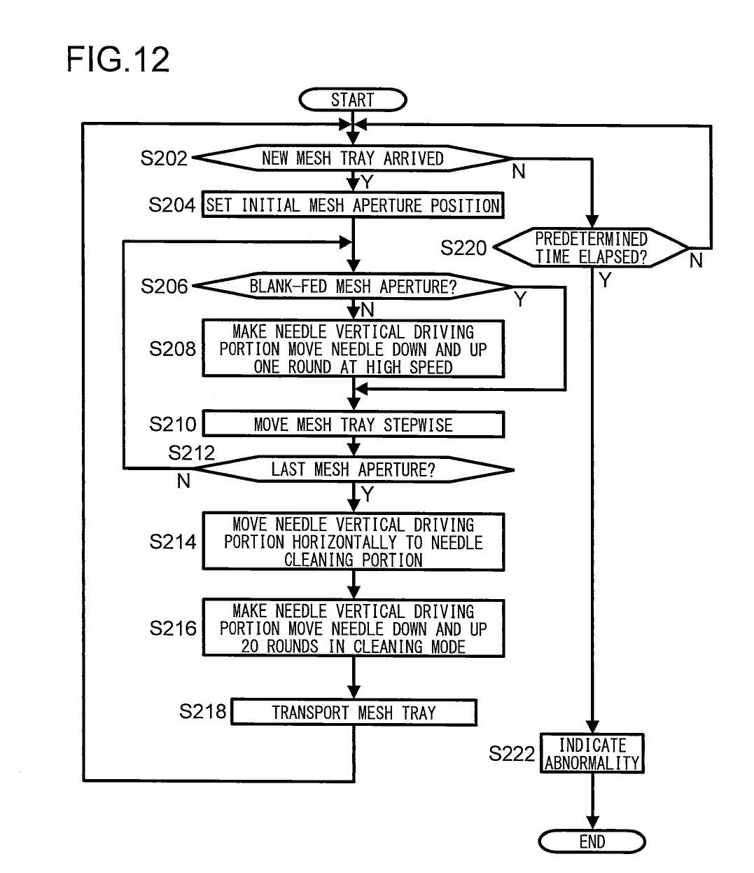

FIG. 12 too is a flow chart showing the function of the larva pricking control portion 426 in FIG. 10, but mainly relates to the control of the pricking transport portion 322. The flow starts when the arraying control portion 320 starts to operate. First, at step S202, it is checked whether or not a new mesh tray 416 having third-instar larvae 70 placed on it has been transported by the mesh tray transport portion 414 to reach a predetermined position in the pricking step-driving portion 424. If it has arrived there, an advance is made to step S204, where the pricking step-driving portion 424 sets an initial mesh-aperture position such that the center of the first mesh aperture of the mesh tray 416 comes right below the needle 326. In a case where the pricking step-driving portion 424 is so designed that whenever the mesh tray 416 arrives, the center of the first mesh aperture comes right under the needle 326, step S204 may be modified to a step for confirming that, or may even be omitted.

Next, an advance is made to step S206, where it is checked whether or not the mesh aperture currently located right below the needle 326 is a “blank-fed mesh aperture.” If not, an advance is made to step S208, where the needle vertical driving portion 418 moves the needle 326 down and up one round at high speed. When, as a result, the pricking of the third-instar larva 70 placed on the mesh aperture right below is completed, an advance is made to step S210, where an instruction is given to move the mesh tray 416 stepwise. On the other hand, if, at step S206, the current mesh aperture is detected to be a “blank-fed mesh aperture,” a direct advance is made to step S210, where an instruction is immediately given to move the mesh tray 416 stepwise. In this case “blank feeding” is effected without down/up movement of the needle 326.

Subsequently, at step S212, it is checked whether or not the mesh aperture reached as a result of the stepwise movement effected in response to the instruction at step S210 is the last mesh aperture. If not, a return is made to step S206, where it is checked whether or not the next mesh aperture is a “blank-fed mesh aperture.” Thereafter, unless the last mesh is detected at step S212, steps S206 through 5212 are repeated, so that the pricking of the third-instar larvae 70 on the mesh tray 416 proceeds.

On the other hand, if, at step S212, the last mesh aperture is detected, an advance is made to step S214, where the needle cleaning horizontal driving portion 420 moves the needle vertical driving portion 418 horizontally so that the needle 326 comes right above the needle cleaning portion (unillustrated in FIG. 10). When the movement is found to be completed, an advance is made to step S216, where the needle vertical driving portion 418 moves the needle 326 down and up 20 rounds in cleaning mode. Next, an advance is made to step S218, where the mesh tray transport portion 414 moves the mesh tray 416 to a third-instar larva election position. At this position, as at the position of the tray 108 in FIG. 3, the mesh tray 416 is tilted, so that the pricked third-instar larvae are moved to the temperature/moisture-maintained container 87.

Then, a return is made to step S202. If, at step S202, no arrival of a new mesh tray 416 is detected, an advance is made to step S220, where it is checked whether or not a predetermined time (for example, 5 minutes) has elapsed without new arrival of a mesh tray 416. If the predetermined time has not elapsed yet, a return is made to step S202, where new arrival is waited for. Thereafter, unless the predetermined time is detected to have elapsed at step S220, steps S202 to S220 are repeated, so that the wait for new arrival of a mesh tray 416 and the pricking of the third-instar larvae 70 on a newly arrived mesh tray 416 are repeated.

If, at step S220, the predetermined time is detected to have elapsed with no arrival of a new mesh tray 416, an advance is made to step S222, where an indication that an abnormality is present at a stage preceding the arraying control portion 320 is given, and the flow ends.

The present invention may be implemented in many variations, in any manner other than specifically described above as examples. For example, in Example 3, the cooling bath 316 may be omitted and instead the water current 312 may be directly connected to the water current spreading/arraying portion 402 in FIG. 10. This enables integration of the transport, cleaning, cooling, and spreading of the third-instar larva 70. In this case, to prevent suffocation of larvae in water, it is preferable that all those processes be completed in a predetermined length of time (for example, within 5 to 6 minutes). The different examples described above are not altogether unrelated to one another, but may be blended together, each being implementable with a partial combination modified. For example, Examples 1 and 3 may be blended together into a configuration in which the third-instar larvae 70 are dropped from the conveyor portion 318 in FIG. 9 onto the tray 102 in FIG. 3 and thereafter anesthesia and pricking are performed with the configuration in FIG. 3. Another configuration is also possible in which the third-instar larvae 70 are dropped from the collecting cage 74 in FIG. 3 into the water current spreading/arraying portion 402 in FIG. 10 and thereafter anesthesia and pricking are performed with the configuration in FIG. 10.

To follow is a summary of the various technical features disclosed above.

First, the first technical feature disclosed in the present description relates to feed used in the livestock, marine-products, and like industries, and to a method of and an apparatus for producing such feed.

In the livestock, marine-products, and like industries, it has been common to mix antibiotics to feed to promote growth; nowadays, however, the harm of such antibiotics, when remnant, is recognized. On the other hand, as substitutes for antibiotics as antimicrobial substances, proteins and peptides having an antimicrobial activity have been receiving attention, and proposals have been made to mix these to feed.

Unfortunately, however, no sufficient studies seem to have been made on specific methods of, specific apparatuses for, or other details about producing feed mixed with a protein or peptide having an antimicrobial activity.

In view of the foregoing, the first technical feature disclosed in the present description provides a specific composition of, and a method of producing, feed mixed with a protein or peptide having an antimicrobial activity, and to provide an apparatus for pricking (puncturing) fly larvae (maggots) for the production of a peptide having an antimicrobial activity.

Specifically, according to the present description, as one example of the first technical feature mentioned above, feed is provided which contains at least part of an insect larva having an antimicrobial activity. This makes it possible to industrially produce feed having an antimicrobial activity. Moreover, according to a specific feature described in the present description, one of the most suitable insects is flesh-flies (Sarcophaga (Boettcherisca) peregrina). This feature provides advantages for mass production of feed, such as low cost of larva sustenance, a short period of generation change, and high antimicrobial-activity substance production efficiency.

Moreover, according to a specific feature described in the present description, the feed contains at least part of a flesh fly larva with no residual sustenance component remaining in its body. This makes it possible to mix part of a flesh fly larva in the feed without contamination. According to a detailed feature described in the present description, the feed contains at least part of a flesh fly larva that is pricked and then kept away from sustenance for a while with moisture maintained. Furthermore, according to another detailed feature described in the present description, the feed contains at least part of a flesh fly larva that is kept away from sustenance for a while with moisture maintained and then pricked. In these features, keeping the larva away from sustenance for a while is one specific way to wait for sufficient digestion of the residual sustenance in the larva body and thereby prevent it from contaminating the feed. On the other hand, maintaining moisture serves to prevent the larva from growing into a pupa and thereby prevent excessive solid matter from mixing in the feed, and is thus one specific way to mix at least part of the flesh-fly larva in the feed.

According to a specific feature described in the present description, the feed contains the entire components of the insect larva. This eliminates the need for a process for extracting a substance having an antimicrobial activity from the larva, and makes it possible to industrially produce feed having an antimicrobial activity. According to another specific feature described in the present description, the feed contains the insect larva in a crushed form. This feature is accompanied by the feature that the feed contains the cuticular layer present at the surface of the body of the insect larva.

According to another feature described in the present description, a method for producing feed is provided which includes: a first step of obtaining an insect larva having an antimicrobial activity; a second step of drying the larva; and a third step of mixing at least part of the larva having undergone the second step in feed. This makes it possible to industrially produce feed having an antimicrobial activity. According to a specific feature described in the present description, the method further includes a step of crushing the dry larva having undergone the second step, so that the larva crushed in this step is fed to the third step mentioned above. These processes of drying and crushing make it possible to industrially produce feed having an antimicrobial activity.

According to another specific feature described in the present description, the first step includes a step of separating the insect larva, a step of pricking the separated larva, and a step of waiting for the pricked larva to express an antimicrobial activity. This makes it possible to industrially obtain an insect larva having an antimicrobial activity. According to yet another specific feature described in the present description, the first step further includes a step of refrigeration-anesthetizing the larva when pricking it. This makes it possible to industrially obtain an insect larva having an antimicrobial activity.

According to another specific feature described in the present description, the first step further includes a step of arraying the larva for pricking, a step of detecting the position of each larva so arrayed, and a step of positioning a pricking needle at each position so detected. This makes efficient pricking of the larva possible, and makes it easy to industrially obtain an insect larva having an antimicrobial activity.

According to another feature described in the present description, an apparatus for producing feed is provided which includes: a drying portion for drying an insect larva having an antimicrobial activity; a crushing portion for crushing the dried larva to obtain crushed powder; a checking portion for extracting part of the crushed powder to check for production of an antimicrobial peptide; and a mixing portion for mixing in feed the crushed powder in which production of an antimicrobial activity has been confirmed by the checking portion. This makes it possible to produce feed having an antimicrobial activity with stable product quality.

According to another feature described in the present description, an apparatus for producing feed is provided which includes: an imago rearing portion; a larva rearing portion for rearing larvae obtained from imagoes; a distributing portion for distributing part of the larvae obtained from the larva rearing portion for expression of an antimicrobial activity and another part for imago emergence; a control portion for controlling the distribution by the distributing portion based on information on larvae obtained from the larva rearing portion; and a mixing portion for mixing in feed an antimicrobial peptide derived from the larvae for expression of an antimicrobial activity. This ensures stable circulation of imagoes, and makes it possible to industrially produce feed. Moreover, according to a specific feature described in the present description, the control portion controls the distribution proportions based on the number per unit time of larvae distributed for expression of an antimicrobial activity.

According to another feature described in the present description, an apparatus for pricking a larva is provided which includes: a cooling portion for cooling an insect larva; a photographing portion for photographing the larva cooled by the cooling portion; a control portion for checking for absence of change between images of the larva photographed at a predetermined time interval to confirm the larva being refrigeration-anesthetized; and a pricking portion for pricking the refrigeration-anesthetized larva for expression of an antimicrobial activity. This makes it possible to confirm a larva being under anesthesia when pricking it, and makes it possible to industrially achieve expression of an antimicrobial activity through the pricking of larvae.

According to another feature described in the present description, an apparatus for pricking a larva is provided which includes: a cooling portion for cooling an insect larva; a photographing portion for photographing the larva cooled by the cooling portion; a pricking needle for pricking the larva refrigeration-anesthetized by the cooling portion for repression of an antimicrobial activity; and a control portion for moving the needle to the position of one larva after another based on an image from the photographing portion. This makes it possible to industrially achieve expression of an antimicrobial activity through the pricking of larvae.

According to another feature described in the present description, an apparatus for pricking a larva is provided which includes: a cooling portion for cooling an insect larva; a larva arraying portion for spreading larvae over the cooling portion; and a pricking needle for pricking the larvae refrigeration-anesthetized by and spread over the cooling portion for expression of an antimicrobial activity. According to a specific feature described in the present description, the larva arraying portion has a vibrating portion for vibrating the larvae to spread the larvae, which form a pile, over the cooling portion. According to another specific feature described in the present description, the larva arraying portion has a water feeding portion for separating the larvae, and separates the larvae, which are adhered together, from one another through the feeding of moisture and the mechanical action of feeding water. According to yet another specific feature described in the present description, the larva arraying portion applies a centrifugal force to the larvae to spread them such that the larvae, which are concentrated at the center of the cooling portion, are spread toward an edge part thereof. Arraying larvae in this way makes it possible to industrially perform the pricking of larvae for expression of an antimicrobial activity.

According to another feature described in the present description, an apparatus for pricking a larva is provided which includes: a pricking needle for pricking an insect larva for expression of an antimicrobial activity; a transport portion for transporting the larva to the position of the pricking needle; and a cleaning portion for cleaning the transport portion. This makes it possible to prevent adhesion of larva tissue or the like to the transport portion, and makes it possible to smoothly carry out the transport process for mass production.

According to another feature described in the present description, an apparatus for pricking a larva is provided which includes: a pricking needle for pricking an insect larva for expression of an antimicrobial activity; and a cleaning portion for cleaning the pricking needle. This makes it possible to prevent adhesion of larva tissue or the like to the needle, and makes it possible to smoothly carry out the pricking process for mass production. According to specific feature described in the present description, the cleaning portion cleans the pricking needle each time pricking has been performed a predetermined number of times. This makes it possible to smoothly carry out continuous processes for mass production. According to another specific feature described in the present description, the cleaning portion cleans the pricking needle on completion of the larva pricking process. This makes it possible to carry out the pricking process for mass production without leaving an adverse effect on the subsequent lot.

Next, the second technical feature disclosed in the present description relates to a method of obtaining a useful substance from an insect.

In recent years, as substitutes for antibiotics as antimicrobial substances, proteins and peptides having an antimicrobial activity have been receiving attention, and proposals have been made to make insects produce them.

Unfortunately, however, no sufficient studies seem to have been made on how to achieve that industrially.

In view of the foregoing, the second technical feature disclosed in the present description provides methods of separating, transporting, and arraying insect larvae, and a method of pricking larvae, for industrially making an insect produce a useful substance.

Specifically, according to the present description, as one example of the second technical feature mentioned above, a method of separating larvae is provided which includes: a first step of rearing fly larvae in a sustenance container; and a second step of collecting larvae creeping out of the container for pupation, the method thereby achieving separation of mature imagoes. With this configuration, separation of larvae from sustenance in the sustenance container is achieved by relying on the behavior of the larvae, and confirmation of the larvae being mature is also achieved. This proves useful, for example, in a case where, by pricking larvae thus separated, an antimicrobial peptide is produced.

According to a specific feature described in the present description, compared with the part of the sustenance container that larvae creep up, the part of it onto which larvae creep out of it is given low adhesion to them. This makes it possible to prompt larvae that have crept up and out of the container according to their behavior to fall off the container. According to another specific feature described in the present description, the second step includes a step of collecting larvae that have crept out of the container with a water current. This makes it possible to efficiently collect larvae that have fallen out of the container.

According to a specific feature described in the present description, a method of transporting larvae is provided which includes: a first step of obtaining an insect larva; and a second step of moving the obtained larva into a water current, the method thus achieving transport and cleaning of the larvae with the water current. Processing larvae requires transporting them for, for example, their pricking, and also requires, as in a case where larvae are as they are crushed and mixed in feed, cleaning them for their later use. For these purposes, transport with a water current is extremely useful.

According to a specific feature described in the present description, the water current in the second step is a current of cold water, and with this cold water current, the larvae are transported, cleaned, and anesthetized. For example, in a case where the transported larvae are pricked so as to be thereby made to produce an antimicrobial peptide, refrigeration-anesthetizing them is convenient to make their pricking easy; thus, transport with cold water also serves as anesthesia.

According to another feature described in the present description, a method of arraying larvae is provided which includes: a first step of obtaining insect larvae; a second step of moving the obtained larvae into a water current; and a third step of arraying the larvae spread by the water current. For example, in a case where the transported larvae are pricked so as to be thereby made to produce an antimicrobial peptide, they need to be arrayed in a spread fashion to make their pricking easy; this can be achieved efficiently with the water current.

According to a specific feature described in the present description, the water current in the second step runs through a passage whose cross-sectional area is increasingly small in the direction of the water current to make it increasingly fast, and this allows the larvae in the water current to spread in the direction of the water current. The larvae are thus separated from one another to be spread at sufficient intervals, and this makes the arraying in the third step easy.

According to another feature described in the present description, a method of arraying larvae is provided which includes: a first step of obtaining insect larvae; a second step of spreading the obtained larvae; and a third step of arraying the spread larvae one after another at a predetermined position. First spreading the larvae and then arraying them one after another in this way makes their pricking easy, for example, in a case where the transported larvae are pricked so as to be thereby made to produce an antimicrobial peptide.

According to a specific feature described in the present description, if, in the third step, a larva cannot be arrayed at a predetermined position within a predetermined time, with no larva arrayed at that position, an advance is made to arraying at the next position. This means that, during the process of larvae being arrayed one after another, when the arraying at a given position is hindered such as by a larva not being supplied in time, with no larva arrayed at that position, an advance is made to arraying at the next position. By prompting arraying in this way, it is possible to prevent inconveniences such as an already arrayed larva starting to move out of the predetermined position as a result of its recovering from anesthesia while arraying is delayed.

According to another specific feature described in the present description, if there is any position at which no larva is arrayed in the third step, that position is recorded. This makes it possible to avoid, for example, moving a pricking needle or the like unnecessarily at a position where no larva is arrayed.

According to yet another specific feature described in the present description, in the third step, a larva that does not meet a standard is not arrayed but ejected. One suitable standard is the weight of larvae. For example, when a larva is too light, it may be broken and unusable; on the other hand, an excessive weight may indicate two or more larvae adhered together, which are difficult to separate and array one by one.

According to still another specific feature described in the present description, in the third step, a larva of which the degree of spread does not meet a standard is not arrayed but ejected. This is because, for example in a case where larvae are supplied continuously without adequate intervals, it is expected to be difficult to determine the timing with which to array them one apart from another.

According to another feature described in the present description, a method of pricking a larva is provided which includes: a first step of obtaining an insect larva; a second step of arraying the obtained larva at a predetermined position; and a third step of pricking the larva based on information on the arraying of the larva at the predetermined position, the method making the larva produce an antimicrobial peptide by pricking it. This makes it possible to efficiently prick an insect at the position at which it is arrayed.

According to a specific feature described in the present description, in the third step, no pricking operation is performed at a position where no larva is arrayed. This is to avoid unnecessary movement of a pricking needle or the like, and can be achieved, for example, based on recorded information on a position where no larva was arrayed.

### INDUSTRIAL APPLICABILITY

The present invention provides a technology useful in industrial production of feed containing a protein or peptide having an antimicrobial activity.

### LIST OF REFERENCE SIGNS

2 Imago rearing section
4 Larva rearing section
6 Larva separation section (Distribution portion)
8 Imago circulation section (Distribution portion)
10 Larva anesthetizing/pricking section
12 Antimicrobial peptide production section
14 Larva freeze-drying section
16 Larva crushing section
18 Production checking section
20 Feed mixing section
22 Production control portion (Control Portion)
24, 26, 28 Partition wall
30 Suction portion
32 Deodorizing portion
34 Exhaust portion
36 Rearing cage
38 Collecting cage
40 Flesh fly (Imago)
42, 44 Imago sustenance container
46 Breeding box
48 Larva sustenance container
50 Suction portion
52 Deodorizing portion
54 Exhaust portion
56 Odor sensor
58 Container transport portion
60 First-instar management portion
62 First-instar larvae
64 Second-instar management portion
66 Second-instar larvae
68 Third-instar management portion
70 Third-instar larva (Insect larva having an antimicrobial activity)
72 Glycerol bath
74 Collecting cage
75 Weighing portion
76 Pupa
78 Tray portion
80 Position sensor portion (Photographing portion)
82 Tray cooling portion
84 Needle driving portion (Pricking portion)
86 Needle (Pricking needle)
87 Temperature/moisture-maintained container
88 Larva powder (Part of an insect larva having an antimicrobial activity)
90 Feed
102, 104, 106, 108, 110 Tray (Transport portion)
112 Tray transport portion
114 Tray vibrating/rotating portion (Larva arraying portion)
116 Illumination portion
118 Camera portion
120 Image processing section
122 Needle vertical driving portion
124 Two-dimensional horizontal driving portion (Control Portion)
126 Needle driving control portion
128 Needle cleaning portion
130 Tray cleaning portion
132 Larva anesthetizing/pricking control portion
202 Breeding-dedicated sustenance box
204 Rearing vessel management portion
208 Larva cleaning portion (Distribution portion)
212 Imago circulation section (Distribution portion)
214 Emergence box
216 Attractant light source
302 Larva escape portion
306 Third-instar weighing portion
308 Weighing portion
310 Water current passage
312 Water current
314 Larva pricking section
316 Cooling bath
318 Conveyor portion
320 Arraying control portion
322 Pricking transport portion
324 Needle driving portion
326 Needle
402 Water current spreading/arraying portion
404 Drop timing control portion
406 Drop opening
408, 416 Mesh tray
410 Arraying step-driving portion
411 Drop sensor
412 Light source
414 Mesh tray transport portion
418 Needle vertical driving portion
420 Needle cleaning horizontal driving portion
422 Needle driving control portion
424 Pricking step-driving portion
426 Larva pricking control portion

1. Feed comprising at least part of an insect larva having an antimicrobial activity.

2. The feed according to claim 1, wherein the insect is a fly.

3. The feed according to claim 2, wherein the feed comprises at least part of a fly larva with no residual sustenance component in a body thereof.

4. The feed according to claim 3, wherein the feed comprises at least part of a fly larva that is pricked and then kept away from sustenance for a while with moisture maintained.

5. The feed according to claim 3, wherein the feed comprises at least part of a fly larva that is kept away from sustenance for a while with moisture maintained and then pricked.

6. The feed according to claim 1, wherein the feed comprises the entire components of the insect larva.

7. The feed according to claim 6, wherein the feed comprises the insect larva in a crushed form.

8. The feed according to claim 6, wherein the feed contains a cuticular layer at a surface of a body of the insect larva.

9. A method of producing feed, comprising: a first step of obtaining an insect larva having an antimicrobial activity; a second step of drying the larva; and a third step of mixing at least part of the larva having undergone the second step in the feed.

10. The method according to claim 9, further comprising a step of crushing the dried larva having undergone the second step, wherein the larva crushed in that step is supplied to the third step.

11. The method according to claim 9, wherein the first step includes a step of separating the insect larva, a step of pricking the separated larva, and a step of waiting for the pricked larva to express an antimicrobial activity.

12. The method according to claim 11, wherein the first step further includes a step of refrigeration-anesthetizing the larva when pricking it.

13. The method according to claim 9, wherein the insect is a fly.

14. The method according to claim 9, further comprising: a fourth step of crushing the insect larva having undergone the second step to obtain crushed powder thereof; and a fifth step of extracting part of the crushed powder to check for production of an antimicrobial activity, wherein in the third step, the crushed powder in which production of an antimicrobial activity has been confirmed in the fifth step is mixed in the feed.

15. The method according to claim 9, wherein the first step includes a step of obtaining the insect larva, a step of moving the obtained larva into a water current, and a step of arraying the larva spread from one another by the water current.

16. The method according to claim 9, wherein the first step includes a step of obtaining the insect larva, a step of spreading the obtained larva from one another, and a step of arraying the spread larva one after another at a predetermined position.

17. A larva pricking apparatus comprising: a larva arraying portion for arraying insect larvae that have been refrigeration-anesthetized; a pricking needle for pricking, for expression of an antimicrobial activity, the insect larvae that have been spread from one another after being refrigeration-anesthetized.

18. The apparatus according to claim 17, further comprising: a transport portion for transporting the larva arraying portion to a position of the pricking needle; and a cleaning portion for cleaning the larva arraying portion.

19. The apparatus according to claim 17, further comprising a needle cleaning portion for cleaning the pricking needle.

20. The apparatus according to claim 17, wherein the insect is a fly.
